(19) United States
(12) Patent Application Publication
(10) Pub. No.: US 2016/0162596 A1
(43) Pub. Date: Jun. 9, 2016

(54) System and Method for Real-time Search Engine Optimization Issue Detection and Correction

(71) Applicants: Hamlet Francisco Batista Reyes, Old Bridge, NJ (US); Robert Stanley Pale, Conowingo, MD (US); Anup Shinde, Ahmedabad (IN); Siddhartha Debgupta, Kolkata (IN); Harold Lawrence Marzan Mercado, Santo Domingo Este (DM)

(72) Inventors: Hamlet Francisco Batista Reyes, Old Bridge, NJ (US); Robert Stanley Pale, Conowingo, MD (US); Anup Shinde, Ahmedabad (IN); Siddhartha Debgupta, Kolkata (IN); Harold Lawrence Marzan Mercado, Santo Domingo Este (DM)

(21) Appl. No.: 14/847,792

(22) Filed: Sep. 8, 2015

Related U.S. Application Data
(60) Provisional application No. 62/046,302, filed on Sep. 5, 2014.

(51) Int. Cl. G06F 17/30

(52) U.S. Cl. CPC G06F 17/30899; G06F 17/30864

(57) ABSTRACT

The present invention will focus on detecting and fixing any potential technical search engine optimization issues in real-time. The required web page changes take place really fast, and made possible by RankSense's VELOZ web page virtualization engine described here. We list detailed fixing processes covering issues that could affect nine example SEO tags: 1. Canonical tags; 2. Redirects; 3. Robots tags; 4. Pagination tags; 5. Hreflang tags; 6. Rel alternate tags (mobile); 7. Vary header; 8. 40x/50x errors; and Search Engine Friendly URLs. In an example process, the Server Module replaces canonical tags on a virtual HTML stream in real-time based on real-time feedback from the Daemon Service or fast lookups to a prepopulated DBM file. A similar approach is taken to detect and fix the issues affecting any of the example SEO tags: redirects, robot tags, etc.

### CROSS REFERENCE TO RELATED APPLICATIONS

This application claims priority from U.S. patent application Ser. 62/046,302, entitled “System and Method for Real-time Search Engine Optimization Issue Detection and Correction”, filed on 5 Sep. 2014. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to search engine optimization. More specifically, the present invention relates to a new method for search engine optimization.

### BACKGROUND OF THE INVENTION

SEO is an acronym for “search engine optimization” or “search engine optimizer.” Search engine optimization is often about making small modifications to parts of a website. When viewed individually, these changes might seem like incremental improvements, but when combined with other optimizations, they could have a noticeable impact on the site's user experience and performance in organic search results.

Search engines are evolving along a number of paths from their early days of keyword matching, which include approaches such as incorporating user-behavior data into ranking pages, creating statistical language models, using semantic ontologies like that from Applied Semantics to become more interactive, understanding phrases better, understanding when phrases may refer to a specific person, place or thing, and more.

SEO is becoming more complex, but the ultimate goal is still to try to find useful and meaningful results for people trying to fulfill informational and situational needs. Search is changing, and the way that people search is changing as well, whether they try to use a conventional search engine or even attempt to have a network of friends and associates provide answers on social sites.

### DEFINITIONS

Physical Page: Html source of specific URL as found in database in a content management system (like Wordpress), or in a text HTML file in the file system Virtual HTML Stream In-memory Html source of specific URL as read and found inside a web server during client request processing.

Permanent Physical Headers: Response headers of specific URL as defined in the web server configuration

Virtual Headers: In-memory response headers of specific URL as set by server and found inside a web server during client request processing Permanent Physical Fixes: These are html or header changes that are permanent in the html source (flat files or CMS/database) Virtual HTML Stream: In-memory Html source of specific URL as read and found inside a web server during client request processing.

Temporary Virtual Fixes: There are html or header changes that are applied in real-time to the in-memory html content and/or headers.

Permanent Physical Fixes. These are html or header changes that are permanent in the html source (flat files or CMS/database)/Server Module: Lightweight web server module/filter that monitors pages for changes notifies daemon service and applies temporary virtual fixes found in a lookup database. The Server Module has two main tasks: Applying real-time fixes found in the Temporary Fixes Map; and Notifying Daemon Service of page changes for further analysis.

Daemon Service: Heavy-duty server process that listens for URL change notifications, compares changes to correct SEO state databases, updates the temporary fixes database(s), and sends reports to real-time dashboard. Daemon Service has three main tasks: Analyzing HTML received from Server Module for potential SEO issues; Adding or removing entries from the Temporary Fixes Map; and Notifying the real-time dashboard when problems are detected, and temporarily or permanently fixed.

Temporary Fixes Maps: DBM file(s) with fixes/changes to perform in real-time to URLs based in lookup. For example, the present invention will have a map with URLs that need the canonical tag replaced. The present invention will have another map for URLs that need the meta robots tag values added/removed. The present invention will also have maps for all SEO tags that could be affected by technical issues. These maps will consist of static URL mappings.

In order to support alternate mobile sites with separate rules, the present invention will add a mobile subdirectory with each of the maps supported, except for the alternate media because is not applicable.

Correct SEO State Maps: DBM file(s) with the correct SEO state of all pages of the site. Similar to the Temporary Fixes Maps, the present invention will have maps for each SEO issue: canonicals, redirects, robots tags, etc.

In order to generalize the solution, the present invention will use primarily page types, in addition to static URL maps. For example, instead of individual canonical mappings for all product URLs, the present invention will have one or more rules to apply to all product URLs as a group. The DS will still insert static URL maps into the Temporary Fixes Maps.

The maps will have page detection rules as regex, or XPATH instructions; and corresponding transformation rules as regex replacements or XSLT rules.

Some elements, like the robots tag, have default values if not present. They should be handled as if they had the default values instead of adding to these maps.

In order to support alternate mobile sites with separate rules, the present invention will add a mobile subdirectory with each of the maps supported, except for the alternate media because is not applicable.

Unknown SEO State Maps: DBM file(s) with the URLs for which their correct SEO state is unknown because they are not matched by any of the rules in the Correct SEO State Maps (and don't have default values).

The purpose of these maps is to periodically review them manually, and add new rules to the Correct SEO State Maps. Similar to the Temporary Fixes Maps, the present invention will have maps for each SEO issue: canonicals, redirects, robots tags, etc. These maps will contain static URL mappings.

In order to support alternate mobile sites with separate rules, the present invention will add a mobile subdirectory with each of the maps supported, except for the alternate media because is not applicable.

### SUMMARY OF THE INVENTION

The present invention will focus on detecting and fixing any potential technical search engine optimization issues that affect the discovery of a website's pages by search engine spiders, and their presentation and ranking in search engine result pages (SERPs). The required web page changes take place really fast, and are made possible by RankSense's VELOZ web page virtualization engine described herein. The present invention describes detailed detection and correction processes affecting nine example SEO tags: Canonical tags; Redirects; Robots tags; Pagination tags; Hreflang tags; Rel alternate tags (mobile); Vary header; 40x/50x errors, and Search Engine Friendly URLs.

For example, the Server Module replaces canonical tags on a virtual HTML stream in real-time based on feedback from the Daemon Service or fast lookups to a prepopulated DBM file. A similar approach is taken to detect and fix each one of the issues affecting any SEO tags (redirects, robot tags etc.)

Web server module(s) should do the minimal processing, like detecting page changes, and updating specific html for a specific set of pages. The Daemon service should do all the heavy lifting: extracting the SEO state of the pages identified as changed, comparing the SEO state with the correct state stored in the maps, updating the temporary fixes database with the correct changes/fixes, and notifying the real-time dashboard of the problems and fixes.

### BRIEF DESCRIPTION OF THE DRAWINGS

The accompanying drawings, which are incorporated herein a form a part of the specification, illustrate the present invention and, together with the description, further serve to explain the principles of the invention and to enable a person skilled in the pertinent art to make and use the invention.

FIG. 1 illustrates the Asynchronous Processes With Change Detection;

FIGS. 2-3 illustrate the real-time dashboard taught by the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

The system of the present invention is doing something commonly done by a combination of SEO experts and website developers. The SEO experts provide insight into what needs to be done, and the developers execute. In this sense, the SEO experts audit the sites to see if it is coded with best practices in mind, and the developers fix any issues found.

What the system of the present invention does is move to an ideal state where the site is getting audited and any technical SEO issues detected are fixed constantly and so fast that it doesn't introduce any noticeable latency to regular website visitor. The latency introduced to page load time by this invention is typically measured under 10 milliseconds. For comparison purposes, a typical analytics pixel adds several multiples of this when pages are loaded.

The present invention improves drastically over a previous design in three areas with respect to: Speed of detection and correction of issues; Transparency of the problems detected and fixed; and Control of what gets fixed and what doesn't (oversight).

These improvements address specific client concerns and needs. As the system is doing changes in real-time, clients get concerned about possible slowdowns that can affect users. Visibility into what the system is doing is also critical to give confidence that the system is not making costly mistakes. Some clients with in-house teams of experts would want to have some control over what the system is doing.

Another novel idea is that most competitors audit the sites by running external crawls. Such a program that would simulate a search engine and visit all pages and links to find issues. The new product of the present invention, audits the site without requiring a crawl, because it passively waits for search engines to visit each page of the site. Let's call this “a passive crawl”. As the search engines visit the site, the audit of each page is triggered.

There are three modes of operation help balance between speed, and results. Async mode is the fastest, but the search engine won't see the fix immediately. Sync is the slowest and useful during debugging and testing. Quicksync provides the best compromise of speed and immediate results.

The Daemon service should do all the heavy lifting: extracting the SEO state of the pages identified as changed, comparing the SEO state with the correct state stored in the maps, updating the temporary fixes database with the correct changes/fixes, and notifying the real-time dashboard of the problems and fixes.

Now referring to the Figures, the embodiment of the present invention is shown. The present invention will focus on detecting and fixing any potential technical SEO issues. Here we list detailed fixing processes for nine example SEO tags: 1. Canonical tags; 2. Redirects; 3. Robots tags; 4. Pagination tags; 5. Hreflang tags; 6. Rel alternate tags (mobile); 7. Vary header; 8. 40x/50x errors; and 9. Search Engine Friendly URLs.

In addition to this, we describe how the invention can be used to fix issues not directly related to Search Engine Optimization. Specifically, we describe how it could be used to correct missing analytics tracking scripts, and pausing or updating paid search ads when their landing pages result in 404 errors.

Web server module(s) should do the minimal processing, like detecting page changes, and updating specific html for a specific set of pages. The Daemon service should do all the heavy lifting: extracting the SEO state of the pages identified as changed, comparing the SEO state with the correct state stored in the maps, updating the temporary fixes database with the correct changes/fixes, and notifying the real-time dashboard of the problems and fixes.

Configuration Settings control the operation of the Server Module and Daemon Service. DSHost Specifies daemon server host or IP; DSPort Specifies daemon server TCP port; SMUserAgent Specifies server module HTTP User Agent string. Default: Server module/version (operating system and version; optional CPU architecture) web server/version. Example: Rank Sense-SM/0.1 (Windows NT step 6.1; WOW64) Microsoft-IIS/7.5

SearchBotPattern Specifies a regular expression pattern to match known search bots.

Example: (Googlebot)|(sabot)|(bingo)|(Yahoo!)|(ia_archiver)|(Ask Jeeves)|(ScoutJet)|(Yandex)|(Baiduspider)

MobileSearchBotPattern Specifies a regular expression pattern to match known mobile search bots. Example: (Googlebot-Mobile)|(iPhone.*Googlebot)

MobileUserPattern Specifies a regular expression pattern to match known search bots. Example: (iPhone)|(Android)|(Windows Phone)

An InspectFor SearchBot (Default) Inspects web traffic filtered by known search bot user agents All Inspect all web traffic.

A ChangeFor SearchBot Applies temporary fixes to web traffic filtered by known search bot user agents.

All (Default) Applies temporary fixes to all web traffic

OnChanges RetryAfter <time in seconds> If InspectFor is set to SearchBot, SM will return HTTP status code step 503, and a expires header with the specified time in seconds (default: step 1 hour). If InspectFor is set to All, this setting will be ignored.

NoWaiting (Default) If InspectFor is set to SearchBot, SM will return the untouched HTML (on DsMode Async), or the fixed HTML (on DsMode Sync)

SmDisable <url parameter> SM should not perform any fixes, or send any request to the DS for any URL with this URL parameter. This setting disables the SM functionality on a per URL basis. This setting must exist in the configuration file for this parameter to take effect.

(default parameter name:_rsf_disable_).

DsTimeOut <time in milliseconds> SM should not wait indefinitely for a response from the DS. This setting will control how long the SM will wait for a DS response, and will treat an elapsed timer like a connection failure (default: step 2 seconds).

DsMode QuickSync SM sends POST request, waits for response including only changed SEO attributes in single query string from DS with content-type “text/plain”. The SM applies the changes to the html and returns the updated html to the client/bot. For example: canonical_url=http://www.site.com/page1&robots= . . . . Values should be byte encoded in UTF-8, even if the page in question has a different encoding specified.

Multiple key=value records are concatenated with a ‘&’ character, and reserved characters are escaped. The present invention current makes an exception to the standard while encoding, but the decoding should work correctly. The present invention will encode all atomic values completely, and non-atomic values like pagination, hreflangs, etc. will have only the sub-values encoded (the part after the key and colon). The exception is the media parameter, where the key will also be escaped, but not the colon separator.

The keys are shown below in a sample response with step 6 fixes—

‘canonical_url=′<canonical fix>’&“robots=′<robots fix>′&”redirects=′<redirect fix>′&“pagination=′<paginations fix>′&”hreflangs=′<hreflangs fix>′&“media=”<alternates fix>

Specific example:

There are three fixes, canonical url http://www.site.com/canonical, hreflang x-default http://www.site.com/interesting %20product/, and media where href is http://www.site.com/mobile/interesting %20product/ and media attribute is “only screen and (max-width: step 6 40px)”. Temporary hash for canonical will have value http://www.site.com/canonical, temporary hash for hreflang will have value x-default:http %3A//www.site.com/interesting %2520product/

(where escaped characters in url is our requirement), and temporary hash for alternate media will have value only %20screen %20and %20%28max-width %3A %20640px %29:http %3A %2F %2Fwww.site.com %2Fmobile %2Finteresting %2520pro duct %2F

QuickSync response will be:

canonical_url=http %3A %2F %2Fwww.site.com %2Fcanonical&hreflangs=x-default:http %253A %2F %2Fwww.site.com %2Finteresting %252520product %2F&media=only % 20screen %20and %20%28max-width %3A %20640px %29:http %3A %2F %2Fwww.site.com %2Fmobile %2Finteresting %2520pro duct %2F

As result of SM processing QuickSync response HTML should have following tags:

<link rel=“canonical” href=“http://www.site.com/canonical”><link rel=“alternate” hreflang=“x-default” href=“http://www.site.com/interesting %20product/”>

Sync SM sends POST request, waits for response including changed HTML (if applicable) from DS, and returns html received to the client/bot.

Async (Default) SM sends POST request to DS, doesn't wait for response, and returns untouched html (on OnChanges NoWaiting), or HTTP status code step 503, and expires header (on OnChanges RetryAfter)

DetectMobile, Yes If this is set to Yes, and the site presents different content to mobile users based on user agent, the SM should make sure the Vary header is set correctly with the value User-Agent. No If this is set to No, and the site presents different content to mobile users based on user agent, the SM should not verify the Vary header is set up correctly.

CacheFixes, Yes this setting is only applicable in QuickSync mode, and it is recommended that the DS and SM use different Temporary Fixes maps. The SM will cache/write the temporary fixes received from the DS to the corresponding Temporary Fixes maps. It needs to encode non-atomic values as needed. It also needs to remove temporary fixes, when the DS reports the problem is corrected.

This setting doesn't affect the DS operation. The DS will always write to the Temporary Fixes maps. But, if this setting is enabled, it is necessary to have separate Temporary Fixes maps. No (Default) this setting prevents the SM from caching updating the temporary fixes.

Important Note: This setting allows for a remote DS. When there is a remote DS, there will be two Temporary Fixes sets. One on the SM machine, and another on the DS machine, and both should be in sync. The DS writes to the Temporary Fixes on its machine, and the SM to the Temporary Fixes on its machine. If the DS mode is not QuickSync, this setting must be ignored.

ClearFixesOnStart, Yes The SM will remove all the existing fixes in the Temporary Fixes maps during module startup. This setting doesn't affect the DS operation. No (Default) This setting prevents the SM from clearing the Temporary Fixes DBMS.

EnableFilter, Yes This setting enables all the SM functionality on the web server, No This setting disables all the SM functionality on the web server

DisplayBanner, Yes (Default) This setting adds the header X-Powered-By, with the value “RankSense/<version number>” to all requests affected by ChangeFor. No This setting disables the header banner.

TrackErrors, Yes This setting instructs the SM to report 40x/50x requests to the DS, No This setting disables reporting 40x/50x requests from the SM to the DS.

FixErrors

Yes this setting instructs the DS to convert step 404 requests to 301 redirects where applicable. No this setting disables step 404 error fixing in the DS.

TemporaryFixesMapsDir

Multi-Domain Support, The DS can handle different domains by looking at the Host header, and assigning directory per domain under each of the directory maps. These in turn will have the expected DBMs.

SupportedDomains, This setting will provide the list of domains the DS handles, and it will create the directories, and files automatically if they don't exist.

Change Detection, There are several approaches to detect page changes that can result SEO issues.

If-Modified-Since: If the webserver is configured to support if-modified-since, the present invention only need to check for 200 status code, as 304 would mean there was no change. This will be our exclusive approach.

In order to keep things simple for now, the SM will communicate with the DS using a simple HTTP POST request with the URL of the page that changed, the Host header with the current site, the other headers received, and the full or partial HTML.

A configuration directive will define whether the communication between the SM and DS is asynchronous, or synchronous. This setting will affect how soon the searchbot sees the fixed pages. In asynchronous mode (default behavior), the search bot will need to request the page again at a later time to see the change. In synchronous mode, it will see the change right away.

Another configuration directive will define whether the SM will return step 503 “retry after” (default behavior) when it detects a page change, or it will return the page unchanged (with an optional recent expires header).

Any request to DS referring to page with https protocol must include X-Secure-Protocol header.

When a requests results in a 40x/50x status code, there is no redirect fix for it, and the TrackErrors setting is set to Yes, the SM will pass the URL to the DS with some extra headers: X-Error-Status-Code with the exact status code, and X-Secure-Protocol with a value to indicate if the protocol is https or not. During 40x/50x errors the present invention will not try to fix them at this stage, but just report them.

During redirect requests, the SM will pass extra headers: Location with the absolute URL of the page being redirected, X-Redirect-Status-Code with the type of redirect, X-Secure-Protocol with a value to indicate if the protocol is https or not, and X-Issue-Status to indicate if the redirect was fixed or not.

In addition to this the present invention forward the client IP and User Agent for logging purposes using the headers: X-User-Agent, and X-IP-Address.

The SM will read the temporary fixes DBM for the Vary header once per reload, and keep the value as a flag in memory. If the UserAgentNeeded value is set to True, the SM will add a new Vary header or replace an existing one so the value User-Agent is included in the list. The first time a change (adding or removing the Vary header) is executed, it will be reported to the DS by passing an extra header to the current DS request, X-Vary-Header-Changed with the old and new values separated by semicolon, as well as X-Issue-Status header indicating new/resolved issue status. Duplicate Vary headers need to be removed automatically.

If the request being sent to the DS originated from a mobile search bot, the present invention need to pass an extra header to indicate this, X-Mobile-Request, with the value smartphone. The present invention will expand this later to cover tablet-optimized sites.

Asynchronous Mode (For Production). SM will send an HTTP POST request with the target URL, headers, and partial or full HTML. The DS will schedule the analysis of the page, and immediately return 200 OK status code and no content.

Synchronous Mode (For Debugging). SM will send an HTTP POST request with the target URL, headers, and partial or full HTML. The DS will analyze the page right away, and return 200 OK status code with the fixes to the page.

Quick Synchronous Mode (For Production). SM will send an HTTP POST request with the target URL, headers, and partial or full HTML. The DS will analyze the page right away, and return 200 OK status code with a list of fixes the SM needs to apply to the page.

In later phases, the inventors will explore using a message queue, to communicate the SM and DS.

Extra Headers. SM will send an HTTP POST request with the target URL, headers, and partial or full HTML. The DS will analyze the page right away, and return 200 OK status code with the fixes to the page.

Daemon Service to Real-time Dashboard. In order to build a prototype as quickly as possible, the present invention will install and configure a status dashboard using an open source package configured as follows:

Services. The specific SEO services/elements the present invention track will be configured manually. Canonicals this will list the current status of all known canonical tags of the site. Redirects this will list the current status of all known redirects of the site. Robots Tags this will list the current status of all known robots tags of the site. Pagination Tags this will list the current status of all known pagination tags of the site. Hreflang Tags this will list the current status of all known hreflang tags of the site. Alternate Tags this will list the current status of all known mobile alternate tags of the site. Vary Header this will list the current status of the vary header. Errors this will list the most critical errors encountered by the search bots Status Levels are a read only configuration that lists all possible status levels. Broken one or more problems have been found with the specific service. Temporarily Fixed the system has placed a temporary solution to the problem detected with the specific service. Permanently Fixed the previously detected problem has been corrected with the specific service. Normally there are no problems with the specific service and last temporary fix was recalled expiration_period days ago.

The DS will POST new statuses to the status dashboard to report new issues or new fixes to the corresponding service, and with the correct status level.

In order to support the Oversight feature, the following changes to the dashboard API are required:

Event object should include following fields:
page—an absolute url of page where problem occurs
problem—problem description.
problem_value—the offending seo key value
correction—correction description
correction_value—proposed correct seo key value
is_approved—if fix is approved from dashboard

There two types of problems: 1. Missing SEO values 2. Incorrect SEO values. For all SEO issues, the present invention will simply say 1. Missing x or 2. Incorrect x. For example:

problem_value=None or Empty, problem=Missing Canonical

correction=Correct Canonical Added

problem_value=Incorrect canonical, problem=Incorrect Canonical

It will work for event list GET/POST and individual event GET list. Event list changes to support datetime range selection and pagination:

start—(string, in whatever format dashboard/analytics sends it, code will parse almost anything resembling date or time)

stop—see start

offset—integer, zero based offset of results to return

limit—integer, limit results to this value

Event instance resource allows for a POST request to allow for enabling/changing/disabling fixes now. Endpoint: /admin/api/v1/services/{service}/events/{sid}

Body parameters:
is_approved=True|False
correction=String, if empty Event will be considered rejected.
Labeling Issues as Critical or Regular

In order to flag issues/events as critical or not, the present invention will need two new DBMs. One to keep track of pages getting organic search traffic, and one to keep track of pages generating revenue from search. The present invention will pull this data from GA on a weekly basis. The initial pull will get data for the past 12 months, subsequent requests will pull data between weeks.

The present invention doesn't need to store pages with zero accumulated traffic.

When the DS reports a new event to the dashboard, it will first check to see if the page affected is included in the traffic or revenue DBM. In such case, the issue will be flagged as critical, and the explanation message should mention the number of visits and/or revenue the page has received.

To allow manipulation of data map files managed by a DS, a simple REST-like API is provided.

Request url structure is as follows:

/api/1.0/(map type 1)/(map type 2)/(seo state)/(domain)

Where map type step 1 is either static or dynamic, for static hash maps or regexes in binary tree files correspondingly, map type step 2 is one of correct, temporary, recovery, unknown, seo state is one of canonical_url, robots, pagination, pagination_limits, hreflangs, and media. Domain is one of domains DS is configured to support.

Four methods are supported: GET, to fetch some or all key/value pairs, PUT, to populate hash/file tree with key/value pairs, POST, to update hash/file tree with key/value pairs, DELETE, to delete all or selected pairs.

Each application user requests should have a JSON body of following structure:

[{‘key’: key_value1}, . . . , {‘key’: key_valuen}] for GET/DELETE

where empty [ ] request means getting all or deleting all requests, or

[{‘key’: key value1, ‘value’: value1}, . . . , {‘key’: key_valuen, ‘value’: valuen}] for PUT/POST

where empty [ ] request is no-op.

Content-type should be set to ‘application/j son’.

All keys and values should be as they have to appear in hashes, meaning values for canonical_url/robots should not be escaped, and pagination/media/etc. should be escaped as described in data formats.

API response is JSON of following structure:

{‘success’: true, results: [ ]} on successful PUT/POST/DELETE

{‘success’: true, results: [{‘key’: key_value1, ‘value’: value1} . . . ]} on successful GET

or

‘success’: false, ‘message’: reason_for_failure′

In order to provide control over SM local caches, a dedicated daemon is provided. Daemon exposes API quite similar to one of DS.

Url structure: /api/1.0//(seo state)/(domain), where seo state is one of canonical_url, robots, pagination, hreflangs, media, redirects, vary, and domain is one of supported domains.

Same four methods, same request and response body formats are used as for DS. Same Content-Type and X-Api-Key headers apply.

A Demo manager daemon handles automatic configuration of demo, setting proxy, SM configuration and DS configuration per given domain.

Url structure: /api/v1/domain(/domain), where optional domain element is domain to take action with.

Three methods are valid: GET, POST and DELETE.

On GET list of domains being served by demo is returned. On POST the provided domain is set as supported by demo. On DELETE the demo stops servicing provided domain, but associated domain data is never removed. Re-enabling this domain will pick this data.

On successful GET a j son encoded plain list of domains will be returned, empty list on failure.

On POST/DELETE a json encoded {“status”: “Success”} or {“Status”: “<Failure reason>”} will be returned.

Note that dashboard is not controlled directly. New domain dashboard is created automatically on first login or event from DS. Dashboards are not removed on DELETE.

Per domain DS behavior could be controlled via settings “correct” hashes. Recognized keys are: oversight with allowed values “True” or “False”, which overrides oversight setting for domain. Remote_oversight with allowed values “True” or “False”, which disables oversight for requests with origins 127.0.0.1 or [::1]. Remote_oversight only will not override global oversight value for remote origins.

To allow sites with really ugly URLs with many dynamic parameters to have nicer, search engine friendly ones, the present invention will support search engine friendly (SEF) URL maps to rewrite the URLs automatically before the web server processes them.

This is the same work URL rewriting modules do, but the present invention will limit it to just internal sub-processing (no redirection), and the Temporary Fixes Maps will be updated dynamically by the DS (by manual input via API for now).

The SM only needs to lookup an incoming URL in the Temporary SEF URL map, and perform a replacement if the URL is found. There is no need to notify the DS. The URLs need to be rewritten before the web server processes them to produce content or generate errors.

Note that SEF Urls can appear in the other DBM tables or in QuickSync messages, but only as values to keep things simple. The DBMs should always use the real URLs as keys. So before the present invention does a lookup, the SEF URL needs to be rewritten to a real one.

The DS will keep set of temporary fixes maps where fixes are staged until they are approved, denied or changed. In other words, the DS will not send the fixes (QuickSync), and will not update the temp fixes right away. The staged fixes will be sent to the dashboard where they will be queued for approval/rejection or change. Once they are approved, they are moved to the temporary fixes map, and return during QuickSync calls as separate lines, starting with the URL(s) fixed. If they are denied, the fixes will be moved to corresponding rejections fixes maps.

The rejection fixes maps will be used to avoid placing rejected fixes again in staging.

In addition to approval, rejection and changes, the present invention will also support reverting approved fixes. In such case, the fixes in temporary state will be moved back to staging.

If DetectMobile is set, it is safe to assume the site has one or more mobile versions of the site. For now, the present invention will support only one (but in the future, the present invention could support more. For example, one for smartphones and one for tablets). The DS will create a mobile subdirectory within each of the directories of maps (Staging, Temporary, Correct).

This configuration assumes the existing hashes only apply to the Desktop pages, and the mobile pages will be updated based on the mobile hashes.

There are step 3 types of mobile sites: Responsive design, Dynamic Serving, and Separate mobile site (generally a subdomain, but can also be a subdirectory or an URL parameter).

In the case of a Responsive design site, the present invention don't need separate rules. The DetectMobile flag needs to be disabled. If the mobile site uses Dynamic Serving, the present invention has mobile specific rules to make sure at least that the Vary header is in place, and there are no redirect mistakes.

The best use case remains the separate mobile site as the present invention also need to make sure the alternate media tags and canonicals are working correctly.

There are three types of mobile visitors: mobile search bots, smartphone users, and feature phone users. The present invention has two settings where the present invention can use regexes to tell search bots from users. The goal is to only forward mobile search bot requests to the DS, and to apply mobile fixes to both mobile search bots, and smartphone/feature phone users.

The Mobile Fixes Maps will have the same DBMS as the directory where it is included. The only exception is that it will not include Alternate Media, and Vary Header DBMS as they are not applicable.

The present invention will fix a subset of all possible step 404 errors. First, let's fix the errors that result from a move of a URL to a new location.

The basic idea is to substitute known canonical for a missing url.

In order to this, the DS will keep a map file with page, and canonical_page, where canonical_page is to be extracted from all pages submitted to DS. Once the DS finds a matching valid URL, it will save it to the Temporary fixes Errors DBM and report it to SM so it is available to it even in quicksync mode with caching enabled.

If such canonical is being reported itself as 404, the map record should be purged.

The SM needs to check the temporary errors DBM when it finds a 404 error, apply the fix if found, and report the redirect fix instead of the 404 error.

The present invention will later test doing 404 fixes between URLs of the same type. The present invention added a new DBM file for this.

The 40x/50x reporting and step 404 error fixing will work in conjunction with the real time dashboard to pause or update affected PPC ads running (initially Google Adwords).

The real time dashboard will have API connections to Google Adwords, and later Bing AdCenter. When a new 40x/50x URL is reported that matches the URL of one or more active PPC ads, the corresponding ads will be paused. If a fix is eventually reported from the DS, the corresponding ads will be unpaused, and if the URL changed (due to a redirect fix), the corresponding PPC landing page URL will also be updated.

The ads pausing, unpausing, and landing page URL changes will still be handled as fixes that are under oversight (if applicable), but they will be handled on the dashboard directly instead of the DS.

The present invention will check for incorrect or missing measurement tags, starting with Google Analytics tags. The goal is to remove duplicate tags, add tags on pages missing them, or correct tags with incorrect property Ids, etc.

In order to support this feature, the present invention requires two DBM files: Measurement-Templates, and Measurement-Tags. Measurement-Templates will contain the actual Javascript code that gets inserted/replaced in the pages, but will have placeholders for the values that need to be replaced (_RS_VALUE_). Measurement-Tags will provide the values that replace the placeholders in the templates.

For example: A standard Google Analytics tag would have a ‘ga’ as part of the lookup key in the Measurement-Templates file. The lookup key will also indicate where the tags need to be placed (head, or body). Body insertions will take place before the closing body tag. For example:

ga-head:

```
<script>
  (function(i,s,o,g,r,a,m){i[‘GoogleAnalyticsObject’]=r;i[r]=i[r]||function( ){
  (i[r].q=i[r].q||[ ]).push(arguments)},i[r].1=1*new Date( );a=s.createElement(o),
  m=s.getElementsByTagName(o)[0];a.async=1;a.src=g;m.parentNode.insertBefore(a,m)
  })(window,document,‘script’,‘//www.google-analytics.com/analytics.js’,‘ga’);
  ga(‘create’, ‘_RS_VALUE_’, ‘auto’);
  ga(‘send’, ‘pageview’);
</script>
```

An example corresponding entry in the Measurement-Tags DBM would look like this: /.+:

### ga: UA-0000000-0

This value will replace_RS_VALUE_in the template, and the updated script will be inserted/updated in the head of the corresponding page.
If there are multiple placeholders for a tag in the Measurement-Templates DBM, the corresponding values will be separated by commas in the Measurement-Tags DBM. Their order in the Measurement-Tags must match the order they appear in the Measurement-Templates.

The present invention will add nofollow tags to links that can lead to bot traps. For example, faceted navigation links, event calendar links, etc.

The present invention will specify the links to update by using simple regex URL patterns that match any link on the page, or simplified XPATH rules to match links in specific positions on the page.

As the present invention doesn't use a DOM API, the present invention will need to use simplified XPATH language to access the links the present invention need to tag during our tags processing.

For example:

//a[@class=“faceted link”]->will apply to any links on the page with the class “faceted link”

//a[@id=“faceted link”]->will apply to any links on the page with the id “faceted link”

/html/body/div[5]/a->will apply to any link that can be found under this hierarchy. In order to do this, the parser needs to maintain a FIFO data structure with any open HTML tags received, and remove them as the corresponding closing tag is found.

DBM file will have a key with the lookup URL from the HTTP request, and a value with the correct canonical. For example: URL->Canonical

/index.html->http://www.domain.com/

DBM file will have a key with the lookup URL from the HTTP request, and two values with the correct redirect status code, and correct redirect_to URL. For example:

URL->Status Code, Redirect_To_URL

/index.html->301,http://www.domain.com/Grammar

should be compatible with Python 2.x re library. The present invention will support $0—whole match, $1—first regex group etc.

URL->Status Code, Redirect To_URL

[symbol] ?productid=(\d+)$->301,http://www.domain.com/product-$1

[symbol] ?productid=(\d+)$->301,http://www.domain.com/parent-category

The key is a regular expression after r. The priority will be implicit based on rule insertion order (first has highest priority).

The value could be a static URL, or a regular expression replacement, including captured groups in $[number] variables.

DBM file will have a key with the lookup URL from the HTTP request, and a value with the full contents of the robots tag. For example:

### URL->Robots

/private.html->noindex,nofollow

DBM file will have a key with the lookup URL from the HTTP request, and a value with the correct pagination tags. The URL part of each pagination tag will be escaped to allow for reliable and fast parsing. Examples: URL->Pagination Tags

/page1.html->next:http %3A//www.domain.com/page2.html
/page2.html->
next:http %3A//www.domain.com/page3.html,prev:http %3A//www.domain.com/page1.html

The key is a static URL, and the value is one or two pagination tags separated by commas. Each pagination tag will have a label to indicate its type: prev or next. Urls are expected to have reserved characters escaped as per RFC 3986, meaning for example comma and colon will become %2C and %3A correspondingly.

DBM file will have a key with the lookup URL from the HTTP request, and a value with the correct hreflang tags. Language code should be from http://en.wikipedia.org/wiki/List_of_ISO_639-1_codes, and region code from http://en.wikipedia.org/wiki/ISO_3166-1_alpha-2. The URL part of each hreflang tag will be escaped to allow for easier parsing. Examples:

URL->Hreflang Tags

/index.html->en-US:http %3A//www.domain.com/index.html,en-CA:http %3A//www.domain.com/ca/index.html

The key is a static URL, and the value is one or more hreflang tags separated by commas (in practice should be more two or more). Each hreflang tag will have a lower case label to indicate its language or language and region or default value x-default. Urls are expected to have reserved characters escaped as per RFC 3986, meaning for example comma and colon will become %2C and %3A correspondingly.

DBM file will have a key with the lookup URL from the HTTP request, and a value with the correct mobile alternate tags. The key, and URL parts will be escaped to allow for reliable and fast parsing. Examples:

URL->Alternate Tags

http://www.domain.com/index.html->only %20screen %20and %20%28max-width %3A %20640px %29:http %3A//www.domain.com/phone/index.html,only %20screen %20and %20%28max-width %3A %20768px %29:http %3A//www.domain.com/tablet/index.html

The key is a static URL, and the value is one or more alternate tags separated by commas. Each alternate tag will have a label in lower case to indicate the target device width. This is used to populate the media attribute of the tag. Urls are expected to have commas and colons in url path part quoted as per RFC 3986, meaning %2C and %3A correspondingly.

DBM file will have a key with the name User-Agent-Needed from the HTTP request, and a value with True or False. For example:

### Key->Value

### UserAgentNeeded->True

DBM file will have a key with the search engine friendly URL from the HTTP request, and a value with the real URL. For example:

SEF URL->Real URL

/about-us.html->/index.php?post_id=3
The key is a static alias URL, and the value is the corresponding internal URL as a static URL too.

Grammar should be compatible with Python 2.x re library. The present invention will support $0—whole match, $1—first regex group etc.

SEF URL->Real URL

[symbol]

?productid=(\d+)$->http://www.domain.com/product-$1
/about-us-(\d+).html->/index.php?post_id=$1

The key is a regular expression. The priority will be implicit based on rule insertion order (first has highest priority).

The value could be a static URL, or a regular expression replacement, including captured groups in $[number] variables.

DBM file will have a key with the lookup URL from the HTTP request, and a value with the correct measurement tag. Example: Static URL Mapping

URL->Measurement Tag

/index.html->ga:0000000

The key is a static URL, and the value in this case is the corresponding Google Analytics property id.

The present invention needs to use the corresponding Measurement-Template DBM to produce the complete Javascript code to insert/update, and also determine the correct location (head or body).

DBM file will have a key with the lookup URL from the HTTP request, and a value with the simplified XPATH rule of the links to be nofollowed. Example: Static URL Mapping

URL->Nofollow Links

/index.html->/faceted-navigation\?filter=

/calendar.html->//a[@id=“calendar event”]

/index.html->/html/body/div[5]/a

The key is a static URL, and the value is a simplified XPATH rule to match the links to add the nofollow attribute.

In the first example, the present invention will apply to any links on the page with the regex URL pattern provided.

In the second example, the present invention will apply to any links on the page with the id “calendar event”.

In the third example will apply to any link that can be found under this hierarchy.

The DBM file will have a key with the lookup URL from the HTTP request, and a value with the correct canonical. For example:

URL->Canonical

/index.html->http://www.domain.com/

The DBM file will have a key with the lookup URL from the HTTP request, and two values with the correct redirect status code, and correct redirect_to URL. For example:

URL->Status Code, Redirect_To_URL

/index.html->301,http://www.domain.com/The

DBM file will have a key with the lookup URL from the HTTP request, and a value with the full contents of the robots tag. For example:

URL->Robots

/private.html->noindex,nofollow

The DBM file will have a key with the lookup URL from the HTTP request, and a value with the correct pagination tags. The URL part of each pagination tag will be escaped to allow for reliable and fast parsing. Examples:

URL->Pagination Tags

/page1.html->next:http %3A//www.domain.com/page2.html

/page2.html->

next:http %3A//www.domain.com/page3.html,prev:http %3A//www.domain.com/page1.html

The key is a static URL, and the value is one or two pagination tags separated by commas. Each pagination tag will have a label to indicate its type: prev or next. Urls are expected to have reserved characters escaped as per RFC 3986, meaning for example comma and colon will become %2C and %3A correspondingly.

The DBM file will have a key with the lookup URL from the HTTP request, and a value with the correct hreflang tags. Language code should be from http://en.wikipedia.org/wiki/List_of_ISO_639-1_codes, and region code from http://en.wikipedia.org/wiki/ISO_3166-1_alpha-2. The URL part of each hreflang tag will be escaped to allow for easier parsing. Examples:

URL->Hreflang Tags

/index.html->en-US:http %3A//www.domain.com/index.html,en-CA:http %3A//www.domain.com/ca/index.html

The key is a static URL, and the value is one or more hreflang tags separated by commas (in practice should be more two or more). Each hreflang tag will have a lower case label to indicate its language or language and region or default value x-default. Urls are expected to have reserved characters escaped as per RFC 3986, meaning for example comma and colon will become %2C and %3A correspondingly.

The DBM file will have a key with the lookup URL from the HTTP request, and a value with the correct mobile alternate tags. The key, and URL parts will be escaped to allow for reliable and fast parsing. Examples:

URL->Alternate Tags

http://www.domain.com/index.html->only %20screen %20and %20%28max-width %3A %20640px %29:http %3A//www.domain.com/phone/index.html,only %20screen %20and %20%28max-width %3A %20768px %29:http %3A//www.domain.com/tablet/index.html

The key is a static URL, and the value is one or more alternate tags separated by commas. Each alternate tag will have a label in lower case to indicate the target device width. This is used to populate the media attribute of the tag. Urls are expected to have commas and colons in url path part quoted as per RFC 3986, meaning %2C and %3A correspondingly.

The DBM file will have a key with the name User-Agent-Needed from the HTTP request, and a value with True or False. For example:

Key->Value

UserAgentNeeded->True

### Errors

DBM file will have a key with the lookup 404 URL from the HTTP request, and two values with the correct redirect status code, and correct redirect_to URL. For example:

URL->Status Code, Redirect_To_URL

/index.html->301,http://www.domain.com/

Correct SEO State Maps Data Format

(Used by DS)

These maps will support, static URL mappings, Regex replacement (like mod_rewrite), and XSLT/Xpath transformations for content.

As multiple rules could match the same URL, a priority will be needed. Matching will be performed in priority order, with no processing after first match. Static map match happens before rule match; in case of static match no rule match will be attempted. But, if there is no static URL map, the present invention will try all rule matches.

The present invention will have two types of maps for each type of SEO issue: a hash map for simple static URL mappings, and a file tree map to hold the dynamic rules. The insertion order will specify the priority implicitly.

For the moment, the Correct SEO State Maps will be updated manually with the help of scripts. Dynamic rules should be compiled once during startup, and their output cached in memory for subsequent requests. A near term approach will be to send the DS a signal to purge the cache and avoid a restart.

The DBM file will have a key with the lookup URL from the HTTP request, and a value with the correct canonical. Examples:

Static URL Mapping

URL->Canonical

/index.html->http://www.domain.com/

The key is a static URL, and the value is the corresponding canonical as a static URL too.

Regex URL Mapping

Grammar should be compatible with Python 2.x re library. The present invention will support $0—whole match, $1—first regex group etc.

URL->Canonical

/?productid=(\d+)$->http://www.domain.com/product-$1

/?productid=(\d+)$->http://www.domain.com/parent-category

The key is a regular expression after r. The priority will be implicit based on rule insertion order (first has highest priority).

The value could be a static URL, or a regular expression replacement, including captured groups in $[number] variables.

XSLT URL Mapping

URL->Canonical

x//div[@class=“productname”]′->http://www.domain.com/$1

x//div[@class=“productname”]′->XSLT transformation rule

The key is a xpath expression after x. The priority will be implicit based on rule insertion order (first has highest priority).

The value could be a static URL, or a regular expression replacement using the value captured from the xpath, or an XSLT transformation applied to the body of the page.

The DBM file will have a key with the lookup URL from the HTTP request, and two values with the correct redirect status code, and correct redirect_to URL. For example:

Static URL Mapping

URL->Status Code, Redirect_To_URL

/index.html->301,http://www.domain.com/

The key is a static URL, and the value is the corresponding redirect URL as a static URL too.

Regex URL Mapping

Grammar should be compatible with Python 2.x re library. The present invention will support $0—whole match, $1—first regex group etc.

URL->Status Code, Redirect_To_URL

[symbol] ?productid=(\d+)$->301,http://www.domain.com/product-$1

[symbol] ?productid=(\d+)$->301,http://www.domain.com/parent-category

The key is a regular expression after r. The priority will be implicit based on rule insertion order (first has highest priority).

The value could be a static URL, or a regular expression replacement, including captured groups in $[number] variables.

The DBM file will have a key with the lookup URL from the HTTP request, and a value with the full contents of the robots tag. If the URL doesn't have an entry in the maps, a default value is assumed. For example:

Static URL Mapping

URL->Robots Tag

/private.html->noindex, nofollow

The key is a static URL, and the value is the full contents of the robots tag. Default value: index, follow

Regex URL Mapping

Grammar should be compatible with Python 2.x re library. The present invention will support $0—whole match, $1—first regex group etc.

URL->Robots Tag

r [symbol] ?productid=(\d+)$->index,follow

The key is a regular expression after r. The priority will be implicit based on rule insertion order (first has highest priority).

The value should always be a valid robots tag value. There is no obvious need for regular expression replacement. Default value: index, follow

The DBM file will have a key with the lookup URL from the HTTP request, and a value with the correct pagination tags. Examples:

Static URL Mapping

URL->Pagination Tags

/page1.html->next:http %3A//www.domain.com/categoryid %3D %241%26page %3D2

/page2.html->

next:/categoryid %3D %241%26page %3D3%2C,prev:http %3A//www.domain.com/categoryid %3D %241%26page %3D1

/page77.html->prev:http %3A//www.domain.com/categoryid %3D %241%26page %3D1

The key is a static URL, and the value is one or two pagination tags separated by commas. Each pagination tag will have a label to indicate its type: prev or next. There is no particular order for labels.

For each page type, the present invention needs to maintain a “pagination boundary”. It is the last valid page in the set. This page needs to be updated as the set grows or shrinks.

Grammar should be compatible with Python 2.x re library. The present invention will support $0—whole match, $1—first regex group etc.

URL Set->Last Page

[symbol] ? categorytid=1&page=(\d+)$->http:/www.domain.com/?categorytid=1&page=5

The key is a regular expression. The priority will be implicit based on rule insertion order (first has highest priority).

The value is in the same format as static mapping, including captured groups in $[number] variables.

Grammar should be compatible with Python 2.x re library. The present invention will support $0—whole match, $1—first regex group etc.

URL->Pagination Tags

[symbol] A?categorytid=(\d+)&page=1$->

next:http %3A//www.domain.com/categoryid %3D %241%26page %3D2

[symbol] ?categoryid=(\d+)&page=2$->next:/categoryid %3D %241%26page %3D3%2C,prev:http %3A//www.domain.com/categoryid % 3D %241%26page %3D1

The key is a regular expression. The priority will be implicit based on rule insertion order (first has highest priority).

The value is in the same format as static mapping, including captured groups in $[number] variables, where values at next: and prev: are escaped and treated as independent regex replacements.

The DBM file will have a key with the lookup URL from the HTTP request, and a value with the correct hreflang tags. Language code should be from http://en.wikipedia.org/wiki/List_of_ISO 639-1_codes, and region code from http://en.wikipedia.org/wiki/ISO_3166-1_alpha-2.

The DS will report errors to the dashboard for URLs found in the regex DBMs, and ignore everything else (excluding 301 redirect fixes). It will also report step 404 errors that were corrected as 301 redirects. The Regex URL DBM file will have a key with the lookup URL from the HTTP request, and a single value True. It will be used exclusively to match URLs to report to the dashboard. The Static URL DBM will be used to log the last error for a known URL. For example:

Static URL Mapping

URL->Hreflang Tags

/index.html->en-us:http://www.domain.com/index.html,en-ca:http://www.domain.com/ca/index.html

The key is a static URL, and the value is one or more hreflang tags separated by commas (in practice should be more two or more). Each hreflang tag will have a label to indicate its language or language and region. Hreflangs should be explicitly lowercase.

Grammar should be compatible with Python 2.x re library. The present invention will support $0—whole match, $1—first regex group etc.

URL->Hreflang Tags

[symbol] A?productid=(\d+)$->en-us:http %3A//www.domain.com/product-%241,en-ca:http %3A//www.domain.com/product-%241

The key is a regular expression after r. The priority will be implicit based on rule insertion order (first has highest priority).

The value is one or more hreflang tags separated by commas (in practice should be more two or more). Each hreflang tag will have a label to indicate its language or language and region.

Each value is URL escaped regular expression replacement, including captured groups in $[number] variables.

The DBM file will have a key with the lookup URL from the HTTP request, and a value with the correct mobile alternate tags. Examples:

Static URL Mapping

URL->Alternate Tags

http://www.domain.com/index.html->only screen and (max-width: step 6 40px):http://www.domain.com/phone/index.html,only screen and (max-width: step 7 68px):http://www.domain.com/tablet/index.html

The key is a static URL, and the value is one or more alternate tags separated by commas. Each alternate tag will have a label to indicate the target device width. This is use to populate the media attribute of the tag.

Regex URL Mapping

Grammar should be compatible with Python 2.x re library. The present invention will support $0—whole match, $1—first regex group etc.

URL->Alternate Tags (labels and values are shown not escaped here, for readability).

[symbol] ?productid=(\d+)$->only screen and (max-width: step 6 40px):http://www.domain.com/phone/product-$1,only screen and (max-width: step 7 68px):http://www.domain.com/tablet/product-$1

The key is a regular expression after r. The priority will be implicit based on rule insertion order (first has highest priority).

The value is one or more alternate tags separated by commas. Each alternate tag will have an url escaped label to indicate the target device width. This is used to populate the media attribute of the tag.

Each URL is a URL escaped regular expression replacement, including captured groups in $[number] variables.

The DBM file will have a key with the name User-Agent-Needed from the HTTP request, and a value with True or False. For example:

Key->Value

UserAgentNeeded->True

The DS will only report errors to the dashboard for URLs found in the regex DBMs, and ignore everything else. The Regex URL DBM file will have a key with the lookup URL from the HTTP request, and a single value True. It will be used exclusively to match URLs to report to the dashboard. The Static URL DBM will be used to log the last error for a known URL. For example:

Static URL Mapping

URL->Status code, Last Update

/index.html->500,1399994882

The key is a static URL, and the value is the status code reported and the last timestamp (in UNIX timestamp format) of the report.

Grammar should be compatible with Python 2.x re library. The present invention will support $0—whole match, $1—first regex group etc.

URL->Report Error?

[symbol] A?productid=(\d+)$->True

[symbol] A?productid=(\d+)$->True

The key is a regular expression after r. The priority will be implicit based on rule insertion order (first has highest priority).

The value doesn't matter much.

There are several approaches to perform live page changes: 1. String or regular expression replacement of text; 2. DOM HTML parsing to find and update HTML elements in a tree; 3. SAX HTML parsing to intercept and update HTML elements as the parser finds them.

String/Regex Replacement should allow for relative fast text processing, but broken HTML and inconsistent opening/closing tags are a big issue with this approach.

DOM HTML Parsing is the slowest approach and consumes the most memory, with a tidying process the present invention can deal with inconsistent opening/closing. This is likely too heavy for real-time HTML analysis.

SAX HTML Parsing should be fast and memory efficient. The challenge will be addressing broken HTML effectively, which is the preferred approach and application of the system and method of the present invention.

Temporary Fixes always take priority over configuration settings. If there are temporary fixes for the requested URL, the fix needs to be applied and the correct status code returned to the client. But, the DS should always receive the original HTML without the fixes to avoid loops.

For example, if DSMode is Async, and there is a temporary fix, the updated HTML needs to be returned to the client instead of the unchanged one. Another example is if OnChanges is Retry-After, and there is a temporary fix, the client should not receive a 503 status code, but the correct status code and the fix. If the present invention doesn't do this, the bot will never get to see the fix until the configuration setting is changed back to NoWaiting.

Physical Canonical Removed (PCR): A User manually edits a page from the site and removes a canonical tag found in the DBM mapping file. When A user requests the page, the canonical needs to be put back, a message about the problem and fix is sent to real-time dashboard.

Physical Canonical Changed (PCC): A User manually edits a page from the site and change a canonical tag found in the DBM mapping file. When A User requests the page, the canonical needs to be replaced for the correct one, a message about the problem and fix is sent to real-time dashboard.

No Change (NC): A User requests the page with a correct canonical as found on the DBM, nothing happens.

Physical Canonical Added Back (PCAB): A User manually edits a page from the site and restores a canonical tag found in the DBM mapping file. When a user requests the page, the module needs to stop inserting/replacing the canonical, a message about the permanent fix is sent to the real-time dashboard

Physical Redirect Removed (PRR): A user manually edits the .htaccess file of the site and removes a 301 redirect found in the DBM mapping file. When a user requests the page, the 301 redirect needs to be put back, a message about the problem and fix is sent to real-time dashboard.

Physical Redirect Changed (PRC): A user manually edits the .htaccess file of the site and change a 301 redirect found in the DBM mapping file to a 302. When a user requests the page, the 302 redirect needs to be replaced for a 301, a message about the problem and fix is sent to real-time dashboard. A user manually edits the .htaccess file of the site and change a 301 redirect found in the DBM mapping file to point to a different url. When a user requests the page, the 301 redirect needs to point to the correct page, a message about the problem and fix is sent to real-time dashboard.

No Change (NC): A user requests the page with a correct 301 redirect as found on the DBM and nothing happens.

Physical Redirect Added Back (PRAB): A user manually edits the .htaccess file of the site and restore a 301 redirect found in the DBM mapping file. When a user requests the page, the module needs to stop inserting/replacing the 301 redirect, a message about the permanent fix is sent to the real-time dashboard

Physical Noindex Removed (PNR): A user manually edits a page from the site and removes noindex from the robots tag for a page marked as True in the DBM mapping file. When a user requests the page, the noindex needs to be put back in the robots tag, a message about the problem and fix is sent to real-time dashboard.

No Change (NC): A user requests the page with a correct noindex in the robots tag for a page marked as True in the DBM and nothing happens.

Physical Noindex Added Back (PNAB): A user manually edits a page from the site and restores the noindex in the robots tag for a page marked as True in the DBM mapping file. When a user requests the page, the module needs to stop inserting/replacing the noindex, a message about the permanent fix is sent to the real-time dashboard

Physical Pagination Tag Removed (PPTR): A user manually edits a page from the site and removes a rel=prev or rel=next tag belonging to a URL found in the DBM mapping file. When a user requests the page, the removed pagination tag needs to be put back, a message about the problem and fix is sent to real-time dashboard.

Physical Pagination Tag Changed (PPTC): A user manually edits a page from the site and change a rel=prev or rel=next tag belonging to a URL found in the DBM mapping file. When a user requests the page, the changed pagination tag needs to be replaced for the correct one, a message about the problem and fix is sent to real-time dashboard.

No Change (NC): A user requests the page with correct pagination tags as found on the DBM nothing happens.

Physical Pagination Tag Added Back (PPTAB): A user manually edits a page from the site and restore a rel=prev or rel=next tag belonging to a URL found in the DBM mapping file. When a user requests the page, the module needs to stop inserting/replacing the pagination tag(s), a message about the permanent fix is sent to the real-time dashboard. The issue should not be considered resolved until all tags are implemented correctly.

New Paginated Page Added (NPPA): A user requests a new paginated page, and as result it is not available in the Correct SEO State maps. The DS needs to update the corresponding Pagination Range map in Correct SEO State maps, so the last page is this one.

Existing Paginated Page Removed (EPPR): A user requests a previously existing paginated page but get a 40x error. The Ds needs to update the corresponding Pagination Range map in the Correct SEO State maps, so it is not longer than the last page, but the corresponding previous page.

Physical Hreflang Tag Removed (PHTR): A user manually edits a page from the site and removes one or more hreflang tags belonging to a URL found in the DBM mapping file. When a user requests he page, the removed hreflang tag needs to be put back, a message about the problem and fix is sent to real-time dashboard.

Physical Hreflang Tag Changed (PHTC): A user manually edits a page from the site and changes one or more hreflang tags belonging to a URL found in the DBM mapping file. When A user requests the page, the changed hreflang tag needs to be replaced for the correct one, a message about the problem and fix is sent to real-time dashboard.

No Change (NC): A user requests the page with correct hreflang tags as found on the DBM nothing happens.

Physical Hreflang Tag Added Back (PHTAB): A user manually edits a page from the site and restores one or more hreflang tags tag belonging to a URL found in the DBM mapping file. When a user requests the page, the module needs to stop inserting/replacing the hreflang tag(s), a message about the permanent fix is sent to the real-time dashboard. The issue should not be considered resolved until all tags are implemented correctly.

Physical Alternate Tag Removed (PATR): A user manually edits a page from the site and removes one or more alternate tags belonging to a URL found in the DBM mapping file. When a user requests the page, the removed alternate tag needs to be put back, a message about the problem and fix is sent to real-time dashboard.

Physical Alternate Tag Changed (PATC): A user manually edits a page from the site and changes one or more alternate tags belonging to a URL found in the DBM mapping file. When a user requests the page, the changed alternate tag needs to be replaced for the correct one, a message about the problem and fix is sent to real-time dashboard.

No Change (NC): A user requests the page with correct alternate tags as found on the DBM nothing happens.

Physical Alternate Tag Added Back (PATAB): A user manually edits a page from the site and restores one or more alternate tags tag belonging to a URL found in the DBM mapping file. When a user requests the page, the module needs to stop inserting/replacing the alternate tag(s), a message about the permanent fix is sent to the real-time dashboard. The issue should not be considered resolved until all tags are implemented correctly.

Vary Header Removed (VHR): A user manually changes the web server settings and removes the Vary header. When a user requests any page, the Vary header needs to be put back, a message about the problem and fix is sent to real-time dashboard.

Vary Header Changed (VHC): A user manually changes the web server settings and change the Vary header to remove the User-Agent attribute, or to duplicate it. When a user requests any page, the Vary header needs to have a single User-Agent value again, a message about the problem and fix is sent to real-time dashboard.

No Change (NC): A user requests any page with and if the Vary header is present, and with the value User-Agent nothing happens.

Vary Header Added Back (VHAB): A user manually changes the web server settings and restores the Vary header to the correct setting. When a user requests any page, the module needs to stop inserting/replacing the Vary header, a message about the permanent fix is sent to the real-time dashboard (if the URL matches the regex in the DBM file).

If the 404 error was the result of a move, when the new URL is sent to the DS for auditing, the checksum will match the one belonging to the 404 page, and a new redirect fix will be created.

40x/50x Error Detected (4ED): A user manually edits the .htaccess file of the site and forces a 40x/50x status code for a URL found in the regex DBM mapping file. When a user requests the page, the 40x/50x error will reach the client/searchbot, but a message about the problem will be sent to the real-time dashboard.

40x/50x Error Corrected (4EC): A user manually edits the .htaccess file of the site and removes the 40x/50x status code for a URL found in the regex DBM mapping file that was placed previously. When a user requests the page, the 40x/50x error will disappear, but a message about the issue now corrected will be sent to the real-time dashboard.

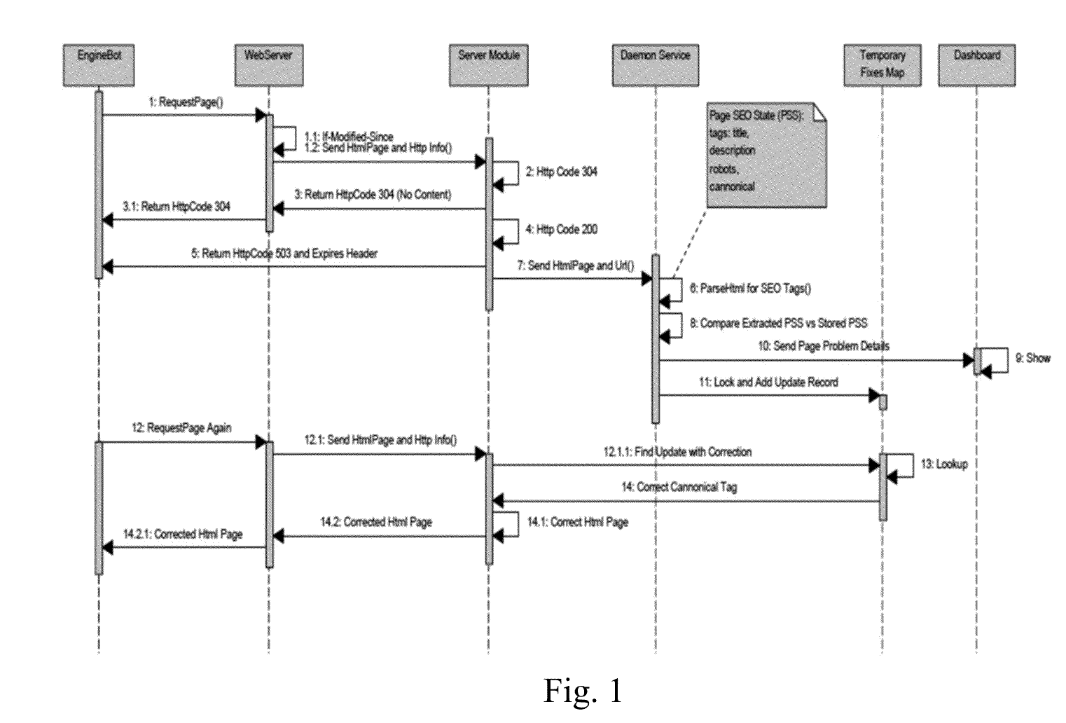

FIG. 1 illustrates the Asynchronous Processes With Change Detection by If-Modified-Since for solving the empty 304 body problem.

In the various steps below, the present invention may need to replace or add html elements (canonicals, meta tags etc.) when the present invention detect a 304 Not Modified on a file for which there is a temporary fix. However, the web server will NOT return a body with a 304 response, so how do the present invention parse non-existent html ? The solution is to always remove the If-Modified-Since header from the incoming request, but store the time in the request context maintained by the filter for the request lifetime. With no If-Modified-Since client header, the web server will never send a 304 Not Modified. Thus, the present invention should always get a 200 OK with the html body. The present invention will also get the Last-Modified response header from any web server, which supports If-Modified-Since and 304 Not Modified. The present invention will look at this Last-Modified response header, and

If last-modified is <=the stored if-modified-since, this is equivalent to a 304 case—the web server would have returned a 304 if the present invention had not removed the incoming If-Modified-Since header.

If there is no temporary fix, the present invention will replace the 200 status code with a 304, remove the body and anybody related headers like Content-Length, Content-Encoding etc.; else if there is a temporary fix, the present invention will apply the fix.

Else (last-modified>the stored if-modified-since), this will be the normal 200 case and would be the same even if the present invention had not removed the incoming If-Modified-Since header.

Now referring to FIG. 1, the Canonical Update Processes where the Physical Canonical Removed (PCR), Physical Canonical Changed (PCC) Server Module (SM) following the following steps: step 1. SM receives, from the webserver, the html source of the page when the visitor is a known search engine (like Googlebot); step 2. SM checks status code is 200 (304 would mean there was no change); step 3. SM sends page HTML, URL to DS; step 4. Depending on configuration settings: in step 4.1, the SM returns the untouched html, and in step 4.2, the SM returns status code 503 (unavailable after) with a preconfigured expiration date/time. In this case, the search bot will not get the page this time, and will try again at a later time (as configured).

Step 5. DS receives the html source of the page, and URL from SM. Step 6. DS parses html source to extract key SEO elements: title, meta description, robots, canonical, etc. The present invention will call these Page SEO State (PSS). Step 7. DS compares the extracted PSS with the stored PSS in the Correct SEO State Maps for the URL, and the canonical tag will be found to be different. Step 8. DS notifies the real-time dashboard that a problem was detected, and provides relevant details. Step 9. DS locks the Temporary Fixes Map, and adds a new update record. Step 10. In this case, the URL received from the SM, and the correct canonical tag extracted from the stored PSS will be inserted in the Temporary Fixes Map. Step 11. DS notifies the real-time dashboard that a temporary fix is in place.

Step 12. SM receives the html source of the page, from the webserver, for the URL found in the Temporary Fixes Map, when the visitor is a known search engine (like Googlebot). Step 13. SM checks status code and gets 304, which means there was no change in step 14. SM looks up the URL in the Temporary Fixes Map, and finds an update with the correct canonical tag.

Step 15. SM parses HTML, and inserts canonical tag in the Virtual HTML Stream

Physical Canonical Added Back (PAB) with respect to the Server Module (SM)

Step 1. SM receives the html source of the page, from the webserver, when the visitor is a known search engine (like Googlebot); step 2. SM checks status code is 200 (304 would mean there was no change); step 3. SM sends page HTML, URL (and optionally checksum) to DS. Step 4. Depending on configuration settings: in step 4.1, the SM returns the untouched html, and in step 4.2, the SM returns status code 503 (unavailable after) with a preconfigured expiration date/time. In this case, the search bot will not get the page this time, and will try again at a later time (as configured)

Step 5. The DS receives the html source of the page, and URL from SM. Step 6. DS parses html source to extract key SEO elements: title, meta description, robots, canonical, etc. The present invention will call these Page SEO State (PSS). Step 7. DS compares the extracted PSS with the stored PSS in the Correct SEO State Maps for the URL, and the canonical tag will be found to be correct. Step 8. DS notifies the real-time dashboard that a permanent fix was detected, and provides relevant details. Step 9. DS locks the Temporary Fixes Map, and removes the corresponding update record. Step 10. In this case, the URL received from the SM, and the correct canonical tag extracted from the stored PSS will be removed from the Temporary Fixes Map

For the No Change (NC) Server Module (SM), Step 13. SM receives the html source of the page, from the webserver, for the URL previously found in the Temporary Fixes Map, when the visitor is a known search engine (like Googlebot). Step 14. SM checks status code is 304, which means there was no change. Step 14. SM looks up the URL in the Temporary Fixes Map, and doesn't find a match. Step 15. SM returns 304 status code with no content.

The Redirect Update Processes for the Physical Redirect Removed (PRR) for the Server Module (SM) starts with step 1. SM receives, from the webserver, the html source of the page when the visitor is a known search engine (like Googlebot); step 2. SM checks status code is 200 (304 would mean there was no change. Step 3. SM sends page HTML, URL to DS; step 4. Depending on configuration settings: Step 4.1 SM returns the untouched html, and step 4.2 SM returns status code step 503 (unavailable after) with a preconfigured expiration date/time. In this case, the search bot will not get the page this time, and will try again at a later time (as configured).

In step 5, the DS receives the html source of the page, and URL from SM; step 6. DS reviews headers and parses html source to extract key SEO elements: title, meta description, robots, canonical, etc. The present invention will call these Page SEO State (PSS); step 7. DS compares the extracted PSS with the stored PSS in the Correct SEO State Maps for the URL, and the page will be found to have the redirect removed; step 8. DS notifies the real-time dashboard that a problem was detected, and provides relevant details; step 9. DS locks the Temporary Fixes Map, and adds a new update record. Step 10. In this case, the URL received from the SM, and the correct redirect extracted from the stored PSS will be inserted in the Temporary Fixes Map. Step 11. DS notifies the real-time dashboard that a temporary fix is in place

In step 12, the SM receives the html source of the page, from the webserver, for the URL found in the Temporary Fixes Map, when the visitor is a known search engine (like Googlebot). Step 13. SM checks status code and gets 304, which means there was no change. Step 14. SM looks up the URL in the Temporary Fixes Map, and finds an update indicating it needs to correctly redirect. Step 15. SM updates the Virtual HTTP Headers to add the correct redirect

The Physical Redirect Added Back (PNAB) starts in step 1. SM receives the HTTP headers, and html source of the page, from the webserver, when the visitor is a known search engine (like Googlebot); Step 2. SM checks status code is 301/302/307 (304 would mean there was no change). Step 3. SM looks up the URL in the Temporary Fixes Map, and finds a match, but it is correct. Step 4. SM sends page URL to DS with no HTML body to indicate the redirect has been fixed

In step 5. DS receives the http headers, and URL with no html source from SM. Step 6. The DS locks the Temporary Fixes Map, finds the URL and removes the corresponding update record. Step 7. In this case, the URL received from the SM, and the correct redirect from the stored PSS will be removed from the Temporary Fixes Map. Step 8. DS notifies the real-time dashboard that a permanent fix was detected, and provides relevant details

Physical Redirect Changed (PRC). In this special case, the SM will do the detection instead of the DS Server Module (SM). Step 1. SM receives, from the webserver, the http headers, and html source of the page when the visitor is a known search engine (like Googlebot). Step 2. SM checks status code is 301/302/307 (304 would mean there was no change). Step 3. SM looks up the URL in the Temporary Fixes Map, and finds no match. Step 4. SM compares the status code, and redirect URL to the ones found in the PSS, and will find that they don't match. The present invention might have incorrect redirect status code or incorrect redirect URL. Step 5. SM updates the Virtual HTTP Headers to add the correct redirect. Step 6. SM sends page URL to DS with no HTML body to indicate the redirect problem.

In step 7, the DS receives the http headers, no html source of the page, and URL from SM. Step 8. The DS locks the Temporary Fixes Map, doesn't find the URL and adds the corresponding update record. Step 9. In this case, the URL received from the SM, and the correct redirect from the stored PSS will be added to the Temporary Fixes Map. Step 10. DS notifies the real-time dashboard that a permanent fix was detected, and provides relevant details In step 11, the SM receives the http headers, and html source of the page, from the webserver, for the URL found in the Temporary Fixes Map, when the visitor is a known search engine (like Googlebot). Step 12. The SM checks status code is 301/302/307 (304 would mean there was no change.) Step 13. The SM looks up the URL in the Temporary Fixes Map, and finds an update indicating it needs to correctly redirect. Step 14. The SM updates the Virtual HTTP Headers to add the correct redirect

In step 15 the SM receives the HTTP headers, and html source of the page, from the webserver, for the URL previously found in the Temporary Fixes Map, when the visitor is a known search engine (like Googlebot). Step 16. SM checks status code is 304, which means there was no change. Step 17. SM looks up the URL in the Temporary Fixes Map, and doesn't find a match. Step 18. SM returns 304 status code with no content.

Robots Tags Update Processes, Physical NoIndex Removed (PNR) starts when in step 1 the SM receives, from the webserver, the html source of the page when the visitor is a known search engine (like Googlebot); in step 2, the SM checks status code is 200 (304 would mean there was no change). Step 3. SM sends page HTML, URL to DS step 4. Depending on configuration settings: in step 4.1, the SM returns the untouched html. Step 4.2. SM returns status code step 503 (unavailable after) with a preconfigured expiration date/time. In this case, the search bot will not get the page this time, and will try again at a later time (as configured.)

In step 5, the DS receives the html source of the page, and URL from SM. Step 6. DS parses html source to extract key SEO elements: title, meta description, robots, canonical, etc. The present invention will call these Page SEO State (PSS). Step 7. DS compares the extracted PSS with the stored PSS in the Correct SEO State Maps for the URL, and the noindex attribute in the robots tag will be found to be different. Step 8. DS notifies the real-time dashboard that a problem was detected, and provides relevant details. Step 9. DS locks the Temporary Fixes Map, and adds a new update record. Step 10. In this case, the URL received from the SM, and the correct robots tag extracted from the stored PSS will be inserted in the Temporary Fixes Map. Step 11. DS notifies the real-time dashboard that a temporary fix is in place.

In step 12, the SM receives the html source of the page, from the webserver, for the URL found in the Temporary Fixes Map, when the visitor is a known search engine (like Googlebot.) Step 13. SM checks status code and gets 304, which means there was no change. Step 14. SM looks up the URL in the Temporary Fixes Map, and finds an update with the correct robots tag. Step 15. SM parses HTML, and inserts robots tag with the noindex attribute in the Virtual HTML Stream

The Physical Noindex Added Back (PNAB) starts with step 1, where the SM receives the html source of the page, from the webserver, when the visitor is a known search engine (like Googlebot). Step 2. SM checks status code is 200 (304 would mean there was no change). Step 3. SM sends page HTML, URL (and optionally checksum) to DS. Step 4. Depending on configuration settings: in step 4.1, the SM returns the untouched html. Step 4.2. SM returns status code 503 (unavailable after) with a preconfigured expiration date/time. In this case, the search bot will not get the page this time, and will try again at a later time (as configured.)

In step 5, the DS receives the html source of the page, and URL from SM. Step 6. DS parses html source to extract key SEO elements: title, meta description, robots, canonical, etc. The present invention will call these Page SEO State (PSS). Step 7. DS compares the extracted PSS with the stored PSS in the Correct SEO State Maps for the URL, and the noindex in the robots tag will be found to be correct. Step 8. DS notifies the real-time dashboard that a permanent fix was detected, and provides relevant details. Step 9. DS locks the Temporary Fixes Map, and removes the corresponding update record Step 10. In this case, the URL received from the SM, and the correct robots tag extracted from the stored PSS will be removed from the Temporary Fixes Map

In step 13, the SM receives the html source of the page, from the webserver, for the URL previously found in the Temporary Fixes Map, when the visitor is a known search engine (like Googlebot). Step 14. SM checks status code is 304, which means there was no change. Step 14. SM looks up the URL in the Temporary Fixes Map, and doesn't find a match. Step 15. SM returns 304 status code with no content

The Pagination Tags Update Processes, Physical Pagination Tag Removed (PPTR), Physical Pagination Tag Changed (PPTC) starts when. Step 1. SM receives, from the webserver, the html source of the page when the visitor is a known search engine (like Googlebot) 2. SM checks status code is 200 (304 would mean there was no change). Step 3. SM sends page HTML, URL to DS. Step 4. Depending on configuration settings: in step 4.1, the SM returns the untouched html. Step 4.2. SM returns status code step 503 (unavailable after) with a preconfigured expiration date/time. In this case, the search bot will not get the page this time, and will try again at a later time (as configured)

In step 5, the DS receives the html source of the page, and URL from SM. Step 6. DS parses html source to extract key SEO elements: title, meta description, robots, canonical, etc. The present invention will call these Page SEO State (PSS). Step 7. DS compares the extracted PSS with the stored PSS in the Correct SEO State Maps for the URL, and a rel=prev or rel=next will be found to be missing. Step 8. DS notifies the real-time dashboard that a problem was detected, and provides relevant details. Step 9. DS locks the Temporary Fixes Map, and adds a new update record. Step 10. In this case, the URL received from the SM, and the correct pagination tag(s) extracted from the stored PSS will be inserted in the Temporary Fixes Map Step 11. DS notifies the real-time dashboard that a temporary fix is in place

In step 12, the SM receives the html source of the page, from the webserver, for the URL found in the Temporary Fixes Map, when the visitor is a known search engine (like Googlebot). Step 13. SM checks status code and gets 304, which means there was no change. Step 14. SM looks up the URL in the Temporary Fixes Map, and finds an update with the correct pagination tag(s). Step 15. SM parses HTML, and inserts the pagination tags in the Virtual HTML Stream

The Physical Pagination Tag Added Back (PPTAB) starts with step 1. SM receives the html source of the page, from the webserver, when the visitor is a known search engine (like Googlebot). Step 2. SM checks status code is 200 (304 would mean there was no change). Step 3. SM sends page HTML, URL (and optionally checksum) to DS. Step 4. Depending on configuration settings: in step 4.1, the SM returns the untouched html. Step 4.2. SM returns status code step 503 (unavailable after) with a preconfigured expiration date/time. In this case, the search bot will not get the page this time, and will try again at a later time (as configured)

In step 5, the DS receives the html source of the page, and URL from SM. Step 6. DS parses html source to extract key SEO elements: title, meta description, robots, canonical, etc. The present invention will call these Page SEO State (PSS). Step 7. DS compares the extracted PSS with the stored PSS in the Correct SEO State Maps for the URL, and the pagination tag(s) will be found to be correct. Step 8. DS notifies the real-time dashboard that a permanent fix was detected, and provides relevant details. Step 9. DS locks the Temporary Fixes Map, and removes the corresponding update record Step 10. In this case, the URL received from the SM, and the correct pagination tag(s) extracted from the stored PSS will be removed from the Temporary Fixes Map

In step 13. SM receives the html source of the page, from the webserver, for the URL previously found in the Temporary Fixes Map, when the visitor is a known search engine (like Googlebot). Step 14. SM checks status code is 304, which means there was no change. Step 14. SM looks up the URL in the Temporary Fixes Map, and doesn't find a match. Step 15. SM returns 304 status code with no content

The Hreflang Tags Update Processes, Physical Hreflang Tag Removed (PHTR), Physical Hreflang Tag Changed (PHTC) starts with step 1. SM receives, from the webserver, the html source of the page when the visitor is a known search engine (like Googlebot). Step 2. SM checks status code is 200 (304 would mean there was no change). Step 3. SM sends page HTML, URL to DS. Step 4. Depending on configuration settings: in step 4.1, the SM returns the untouched html. Step 4.2. SM returns status code step 503 (unavailable after) with a preconfigured expiration date/time. In this case, the search bot will not get the page this time, and will try again at a later time (as configured)

In step 5, the DS receives the html source of the page, and URL from SM. Step 6. DS parses html source to extract key SEO elements: title, meta description, robots, canonical, etc. The present invention will call these Page SEO State (PSS). Step 7. DS compares the extracted PSS with the stored PSS in the Correct SEO State Maps for the URL, and one or more hreflang tags will be found to be missing. Step 8. DS notifies the real-time dashboard that a problem was detected, and provides relevant details. Step 9. DS locks the Temporary Fixes Map, and adds a new update record Step 10. In this case, the URL received from the SM, and the correct hreflang tag(s) extracted from the stored PSS will be inserted in the Temporary Fixes Map Step 11. DS notifies the real-time dashboard that a temporary fix is in place

In step 12. SM receives the html source of the page, from the webserver, for the URL found in the Temporary Fixes Map, when the visitor is a known search engine (like Googlebot). Step 13. SM checks status code and gets 304, which means there was no change Step 14. SM looks up the URL in the Temporary Fixes Map, and finds an update with the correct hreflang tag(s). Step 15. SM parses HTML, and inserts the hreflang tags in the Virtual HTML Stream

The Physical Hreflang Tag Added Back (PHTAB) starts with step 1. SM receives the html source of the page, from the webserver, when the visitor is a known search engine (like Googlebot). Step 2. SM checks status code is 200 (304 would mean there was no change). Step 3. SM sends page HTML, URL (and optionally checksum) to DS. Step 4. Depending on configuration settings: in step 4.1, the SM returns the untouched html. Step 4.2. SM returns status code step 503 (unavailable after) with a preconfigured expiration date/time. In this case, the search bot will not get the page this time, and will try again at a later time (as configured) In step 5, the DS receives the html source of the page, and URL from SM. Step 6. DS parses html source to extract key SEO elements: title, meta description, robots, canonical, etc. The present invention will call these Page SEO State (PSS). Step 7. DS compares the extracted PSS with the stored PSS in the Correct SEO State Maps for the URL, and the hreflang tag(s) will be found to be correct. Step 8. DS notifies the real-time dashboard that a permanent fix was detected, and provides relevant details. Step 9. DS locks the Temporary Fixes Map, and removes the corresponding update record Step 10. In this case, the URL received from the SM, and the correct hreflang tag(s) extracted from the stored PSS will be removed from the Temporary Fixes Map

In step 13, the SM receives the html source of the page, from the webserver, for the URL previously found in the Temporary Fixes Map, when the visitor is a known search engine (like Googlebot). Step 14. SM checks status code is 304, which means there was no change Step 14. SM looks up the URL in the Temporary Fixes Map, and doesn't find a match. Step 15. SM returns 304 status code with no content

The Alternate Tags Update Processes, Physical Alternate Tag Removed (PATR), Physical Alternate Tag Changed (PATC) starts with step 1. SM receives, from the webserver, the html source of the page when the visitor is a known search engine (like Googlebot). Step 2. SM checks status code is 200 (304 would mean there was no change). Step 3. SM sends page HTML, URL to DS. Step 4. Depending on configuration settings: in Step 4.1, the SM returns the untouched html. In Step 4.2, the SM returns status code step 503 (unavailable after) with a preconfigured expiration date/time. In this case, the search bot will not get the page this time, and will try again at a later time (as configured).

In step 5, the DS receives the html source of the page, and URL from SM. Step 6. DS parses html source to extract key SEO elements: title, meta description, robots, canonical, etc. The present invention will call these Page SEO State (PSS). Step 7. DS compares the extracted PSS with the stored PSS in the Correct SEO State Maps for the URL, and one or more alternate tags will be found to be missing. Step 8. DS notifies the real-time dashboard that a problem was detected, and provides relevant details. Step 9. DS locks the Temporary Fixes Map, and adds a new update record. Step 10. In this case, the URL received from the SM, and the correct alternate tag(s) extracted from the stored PSS will be inserted in the Temporary Fixes Map. Step 11. DS notifies the real-time dashboard that a temporary fix is in place

In step 12. SM receives the html source of the page, from the webserver, for the URL found in the Temporary Fixes Map, when the visitor is a known search engine (like Googlebot). Step 13. SM checks status code and gets 304, which means there was no change. Step 14. SM looks up the URL in the Temporary Fixes Map, and finds an update with the correct alternate tag(s). Step 15. SM parses HTML, and inserts the hreflang tags in the Virtual HTML Stream

The Physical Alternate Tag Added Back (PATAB) starts with step 1. SM receives the html source of the page, from the webserver, when the visitor is a known search engine (like Googlebot). Step 2. SM checks status code is 200 (304 would mean there was no change). Step 3. SM sends page HTML, URL (and optionally checksum) to DS. Step 4. Depending on configuration settings: in step 4.1, the SM returns the untouched html. Step 4.2. SM returns status code step 503 (unavailable after) with a preconfigured expiration date/time. In this case, the search bot will not get the page this time, and will try again at a later time (as configured).

In step 5, the DS receives the html source of the page, and URL from SM. Step 6. DS parses html source to extract key SEO elements: title, meta description, robots, canonical, etc. The present invention will call these Page SEO State (PSS). Step 7. DS compares the extracted PSS with the stored PSS in the Correct SEO State Maps for the URL, and the alternate tag(s) will be found to be correct. Step 8. DS notifies the real-time dashboard that a permanent fix was detected, and provides relevant details. Step 9. DS locks the Temporary Fixes Map, and removes the corresponding update record. Step 10. In this case, the URL received from the SM, and the correct alternate tag(s) extracted from the stored PSS will be removed from the Temporary Fixes Map

In step 13, the SM receives the html source of the page, from the webserver, for the URL previously found in the Temporary Fixes Map, when the visitor is a known search engine (like Googlebot). Step 14. SM checks status code is 304, which means there was no change. Step 14. SM looks up the URL in the Temporary Fixes Map, and doesn't find a match. Step 15. SM returns 304 status code with no content

Vary header update processes take regardless of URL requested, or whether there are changes to the body of the pages. The inspection and correction takes place on the SM, not in the DS like other SEO issues. The temporary SEO state will be cached in memory during web server start/restart. The DS will be notified just once per Vary header change. The updates to the Vary header Temporary Fixes Map will be done manually.

Physical Vary Header Removed (PVHR) starts with step 1. SM receives, from the webserver, the headers of the page when the visitor is a known search engine (like Googlebot). Step 2. SM checks the correct SEO state for the Vary header and will find that the User-Agent value needs to be present, but the Vary header is missing. Step 3. SM adds the Vary header back to the client response, and includes the value “User-Agent”. Step 4. SM sends page HTML (if available), URL to DS, and the extra header X-Vary-Header-Changed, with the before and after values separated by semicolon. In this case: “;User-Agent”. Step 5. Depending on configuration settings and other SEO issues that triggered the request, the response to the client will follow the usual course.

In step 5, the DS receives the html source of the page (if applicable), and URL from SM. Step 6. DS reviews headers and parses html source to extract key SEO elements: title, meta description, robots, canonical, etc. The present invention will call these Page SEO State (PSS). Step 7. DS compares the extracted PSS with the stored PSS in the Correct SEO State Maps for the URL, and the page will be found to have the Vary header removed (among potentially other issues). Step 8. DS notifies the real-time dashboard that one (Vary header issue) or more problems were detected, and provides relevant details. Step 9. If there are other issues besides the Vary header, the DS locks the Temporary Fixes Map, and adds a new update record. Step 10. In this case, the URL received from the SM, and the correct SEO issue extracted from the stored PSS will be inserted in the Temporary Fixes Map. Step 11. DS notifies the real-time dashboard that a temporary fix is in place

The Physical Vary Header Added Back (PVHAB) starts with step 1. SM receives, from the webserver, the headers of the page when the visitor is a known search engine (like Googlebot). Step 2. SM checks the correct SEO state for the Vary header and will find that the User-Agent value needs to be present, and the Vary header has been added back with the value “User-Agent”. Step 3. SM stops adding the Vary header to the client response. Step 4. SM sends page HTML (if available), URL to DS, and the extra header X-Vary-Header-Changed, with the before and after values separated by semicolon. In this case: “User-Agent;”. Step 5. Depending on configuration settings and other SEO issues that triggered the request, the response to the client will follow the usual course.

In step 5, the DS receives the html source of the page (if applicable), and URL from SM. Step 6. DS reviews headers and parses html source to extract key SEO elements: title, meta description, robots, canonical, etc. The present invention will call these Page SEO State (PSS). Step 7. DS compares the extracted PSS with the stored PSS in the Correct SEO State Maps for the URL, and the page will be found to have the Vary header added back (among potentially other issues). Step 8. DS notifies the real-time dashboard that the Vary header issue has been resolved, and notifies any other problems detected, and provides relevant details. Step 9. If there are other issues besides the Vary header, the DS locks the Temporary Fixes Map, and adds a new update record. Step 10. In this case, the URL received from the SM, and the correct SEO issue extracted from the stored PSS will be inserted in the Temporary Fixes Map. Step 11. DS notifies the real-time dashboard that a temporary fix is in place

The Physical Vary Header Changed (PVHC) starts with step 1. SM receives, from the webserver, the headers of the page when the visitor is a known search engine (like Googlebot). Step 2. SM checks the correct SEO state for the Vary header and will find that the User-Agent value needs to be present, the Vary header is present, but it doesn't include the value “User-Agent”. Step 3. SM adds the “User-Agent” value to the Vary header in the client response. Step 4. SM sends page HTML (if available), URL to DS, and the extra header X-Vary-Header-Changed, with the before and after values separated by semicolon. In this case: “Accept-Encoding;Accept-Encoding,User-Agent”. Step 5. Depending on configuration settings and other SEO issues that triggered the request, the response to the client will follow the usual course.

In step 5, the DS receives the html source of the page (if applicable), and URL from SM. Step 6. DS reviews headers and parses html source to extract key SEO elements: title, meta description, robots, canonical, etc. The present invention will call these Page SEO State (PSS). Step 7. DS compares the extracted PSS with the stored PSS in the Correct SEO State Maps for the URL, and the page will be found to have the Vary header changed (among potentially other issues). Step 8. DS notifies the real-time dashboard that one (Vary header issue) or more problems were detected, and provides relevant details. Step 9. If there are other issues besides the Vary header, the DS locks the Temporary Fixes Map, and adds a new update record. Step 10. In this case, the URL received from the SM, and the correct SEO issue extracted from the stored PSS will be inserted in the Temporary Fixes Map. Step 11. DS notifies the real-time dashboard that a temporary fix is in place

If there is No Change (NC). Step 1. SM receives, from the webserver, the headers of the page when the visitor is a known search engine (like Googlebot). Step 2. SM checks the correct SEO state for the Vary header and will find that the User-Agent value needs to be present, the Vary header is present, and it includes the value “User-Agent”. Step 3. If there aren't other issues, the SM does nothing. Step 4. Depending on configuration settings and other SEO issues that triggered the request, the response to the client will follow the usual course.

40x/50x Notification Processes and 40x/50x Error Detected (4ED) starts with step 1. SM receives, from the webserver, the html source of the page when the visitor is a known search engine (like Googlebot). Step 2. SM checks status code is 40x/50x step 3. SM sends page URL and extra headers to DS step 4. SM returns the 40x/50x error code to the client/searchbot

In step 5, the DS receives the URL and extra headers from the SM. Step 6. DS reviews headers and determines is a 40x/50x error. Step 7. DS compares the URL with the regexs in the Correct SEO State Maps for the URL, and the page will be found to be a match. Step 8. DS notifies the real-time dashboard that an error was detected, and provides relevant details. Step 9. DS locks the Correct SEO State Map for static URLs, and adds a new update record. Step 10. In this case, the URL received from the SM, the status code, and the current timestamp

40x/50x Error Corrected (4EC) starts with step 1. SM receives the HTTP headers, and html source of the page, from the webserver, when the visitor is a known search engine (like Googlebot). Step 2. SM checks status code is 200/30x (304 would mean there was no change). Step 3. SM looks up the URL in the Temporary Fixes Map, and finds no match. Step 4. SM sends page URL to DS with HTML body if available.

In step 5, the DS receives the http headers, URL and html source if available from SM step 6. DS checks the Correct SEO State maps for static URLs, and finds the URL was previously an error and removes the corresponding update record. Step 7. In this case, the URL received from the SM, and the error status code (and timestamp) will be removed from the Correct SEO State map for static URLs. Step 8. DS notifies the real-time dashboard that a permanent fix was detected, and provides relevant details.

The Synchronous Processes With Change Detection by If-Modified-Since, Canonical Update Processes, Physical Canonical Removed (PCR), Physical Canonical Changed (PCC) starts with step 1. SM receives, from the webserver, the html source of the page when the visitor is a known search engine (like Googlebot). Step 2. SM checks status code is 200 (304 would mean there was no change). Step 3. SM sends page HTML, URL to DS, and gets the fixed page HTML with the correct canonical tag. Step 10. SM returns the fixed html back to the search bot

In step 4, the DS receives the html source of the page, and URL from SM. Step 5. DS parses html source to extract key SEO elements: title, meta description, robots, canonical, etc. The present invention will call these Page SEO State (PSS). Step 6. DS compares the extracted PSS with the stored PSS in the Correct SEO State Maps for the URL, and the canonical tag will be found to be different. Step 7. DS notifies the real-time dashboard that a problem was detected, and provides relevant details. Step 8. DS updates the html received from SM, and inserts the correct canonical tag. Step 9. DS returns the fixed html back to the SM. Step 11. DS locks the Temporary Fixes Map, and adds a new update record. Step 12. In this case, the URL received from the SM, and the correct canonical tag extracted from the stored PSS will be inserted in the Temporary Fixes Map. Step 13. DS notifies the real-time dashboard that a temporary fix is in place

The Physical Canonical Added Back (PAB) starts with step 1. SM receives the html source of the page, from the webserver, when the visitor is a known search engine (like Googlebot). Step 2. SM checks status code is 200 (304 would mean there was no change). Step 3. SM sends page HTML, URL to DS, and gets 304 no change from the DS. Step 10. SM returns the unchanged html back to the search bot, or 304 status code

In step 4, the DS receives the html source of the page, and URL from SM. Step 6. DS parses html source to extract key SEO elements: title, meta description, robots, canonical, etc. The present invention will call these Page SEO State (PSS). Step 7. DS compares the extracted PSS with the stored PSS in the Correct SEO State Maps for the URL, and the canonical tag will be found to be correct. Step 8. DS notifies the real-time dashboard that a permanent fix was detected, and provides relevant details. Step 9. DS returns status code 304 no change to SM. Step 10. DS locks the Temporary Fixes Map, and removes the corresponding update record. Step 11. In this case, the URL received from the SM, and the correct canonical tag extracted from the stored PSS will be removed from the Temporary Fixes Map.

If there is No Change (NC). Step 13. SM receives the html source of the page, from the webserver, for the URL previously found in the Temporary Fixes Map, when the visitor is a known search engine (like Googlebot). Step 14. SM checks status code is 304, which means there was no change. Step 15. SM looks up the URL in the Temporary Fixes Map, and doesn't find a match. Step 16. SM returns 304 status code with no content

The Redirect Update Processes is the same process as described for asynchronous mode because there is not extra work performed by DS. DS main responsibility is to report the redirect issues and fixes to the real-time dashboard and update the temporary fixes database.

The Robots Tags Update Processes, Physical NoIndex Removed (PNR) starts with step 1. SM receives, from the webserver, the html source of the page when the visitor is a known search engine (like Googlebot). Step 2. SM checks status code is 200 (304 would mean there was no change). Step 3. SM sends page HTML, URL to DS, and gets the fixed page HTML with the correct noindex in the robots tag. Step 10. SM returns the fixed html back to the search bot

In step 4, the DS receives the html source of the page, and URL from SM. Step 5. DS parses html source to extract key SEO elements: title, meta description, robots, canonical, etc. The present invention will call these Page SEO State (PSS). Step 6. DS compares the extracted PSS with the stored PSS in the Correct SEO State Maps for the URL, and the noindex in the robots tag will be found to be different. Step 7. DS notifies the real-time dashboard that a problem was detected, and provides relevant details. Step 8. DS updates the html received from SM, and inserts the noindex in the robots tag. Step 9. DS returns the fixed html back to the SM. Step 11. DS locks the Temporary Fixes Map, and adds a new update record. Step 12. In this case, the URL received from the SM, and the correct robots tag extracted from the stored PSS will be inserted in the Temporary Fixes Map. Step 13. DS notifies the real-time dashboard that a temporary fix is in place

The Physical NoIndex Added Back (PAB) starts with step 1. SM receives the html source of the page, from the webserver, when the visitor is a known search engine (like Googlebot). Step 2. SM checks status code is 200 (304 would mean there was no change). Step 3. SM sends page HTML, URL to DS, and gets 304 no change from the DS. Step 10. SM returns the unchanged html back to the search bot, or 304 status code.

In step 4, the DS receives the html source of the page, and URL from SM. Step 6. DS parses html source to extract key SEO elements: title, meta description, robots, canonical, etc. The present invention will call these Page SEO State (PSS). Step 7. DS compares the extracted PSS with the stored PSS in the Correct SEO State Maps for the URL, and the noindex in robots tag will be found to be correct. Step 8. DS notifies the real-time dashboard that a permanent fix was detected, and provides relevant details. Step 9. DS returns status code 304 no change to SM. Step 10. DS locks the Temporary Fixes Map, and removes the corresponding update record. Step 11. In this case, the URL received from the SM, and the correct robots tag extracted from the stored PSS will be removed from the Temporary Fixes Map

If there is No Change (NC). Step 13. SM receives the html source of the page, from the webserver, for the URL previously found in the Temporary Fixes Map, when the visitor is a known search engine (like Googlebot). Step 14. SM checks status code is 304, which means there was no change. Step 15. SM looks up the URL in the Temporary Fixes Map, and doesn't find a match. Step 16. SM returns 304 status code with no content

The Pagination Tags Update Processes, Physical Pagination Tag Removed (PPTR), Physical Canonical Changed (PPTC) starts with step 1. SM receives, from the webserver, the html source of the page when the visitor is a known search engine (like Googlebot). Step 2. SM checks status code is 200 (304 would mean there was no change). Step 3. SM sends page HTML, URL to DS, and gets the fixed page HTML with the correct pagination tag(s). Step 10. SM returns the fixed html back to the search bot

In step 4, the DS receives the html source of the page, and URL from SM. Step 5. DS parses html source to extract key SEO elements: title, meta description, robots, canonical, etc. The present invention will call these Page SEO State (PSS). Step 6. DS compares the extracted PSS with the stored PSS in the Correct SEO State Maps for the URL, and the pagination tag(s) will be found to be different. Step 7. DS notifies the real-time dashboard that a problem was detected, and provides relevant details. Step 8. DS updates the html received from SM, and inserts the correct pagination tag(s). Step 9. DS returns the fixed html back to the SM. Step 11. DS locks the Temporary Fixes Map, and adds a new update record. Step 12. In this case, the URL received from the SM, and the correct pagination tag(s) extracted from the stored PSS will be inserted in the Temporary Fixes Map. Step 13. DS notifies the real-time dashboard that a temporary fix is in place

The Physical Pagination Tag Added Back (PPTAB) starts when in step 1, the SM receives the html source of the page, from the webserver, when the visitor is a known search engine (like Googlebot). Step 2. SM checks status code is 200 (304 would mean there was no change). Step 3. SM sends page HTML, URL to DS, and gets 304 no change from the DS. Step 10. SM returns the unchanged html back to the search bot, or 304 status code

In step 4, the DS receives the html source of the page, and URL from SM. Step 6. DS parses html source to extract key SEO elements: title, meta description, robots, canonical, etc. The present invention will call these Page SEO State (PSS). Step 7. DS compares the extracted PSS with the stored PSS in the Correct SEO State Maps for the URL, and the pagination tag(s) will be found to be correct. Step 8. DS notifies the real-time dashboard that a permanent fix was detected, and provides relevant details. Step 9. DS returns status code 304 no change to SM. Step 10. DS locks the Temporary Fixes Map, and removes the corresponding update record. Step 11. In this case, the URL received from the SM, and the correct pagination tag(s) extracted from the stored PSS will be removed from the Temporary Fixes Map

If there is No Change (NC), Step 13. SM receives the html source of the page, from the webserver, for the URL previously found in the Temporary Fixes Map, when the visitor is a known search engine (like Googlebot). Step 14. SM checks status code is 304, which means there was no change. Step 15. SM looks up the URL in the Temporary Fixes Map, and doesn't find a match. Step 16. SM returns 304 status code with no content

The Hreflang Tags Update Processes, Physical Hreflang Tag Removed (PHTR), Physical Hreflang Changed (PHTC) start with step 1. SM receives, from the webserver, the html source of the page when the visitor is a known search engine (like Googlebot). Step 2. SM checks status code is 200 (304 would mean there was no change). Step 3. SM sends page HTML, URL to DS, and gets the fixed page HTML with the correct hreflang tag(s). Step 10. SM returns the fixed html back to the search bot

In step 4, the DS receives the html source of the page, and URL from SM. Step 5. DS parses html source to extract key SEO elements: title, meta description, robots, canonical, etc. The present invention will call these Page SEO State (PSS). Step 6. DS compares the extracted PSS with the stored PSS in the Correct SEO State Maps for the URL, and the hreflang tag(s) will be found to be different. Step 7. DS notifies the real-time dashboard that a problem was detected, and provides relevant details. Step 8. DS updates the html received from SM, and inserts the correct hreflang tag(s). Step 9. DS returns the fixed html back to the SM. Step 11. DS locks the Temporary Fixes Map, and adds a new update record. Step 12. In this case, the URL received from the SM, and the correct hreflang tag(s) extracted from the stored PSS will be inserted in the Temporary Fixes Map. Step 13. DS notifies the real-time dashboard that a temporary fix is in place

The Physical Hreflang Tag Added Back (PPTAB) starts with step 1. SM receives the html source of the page, from the webserver, when the visitor is a known search engine (like Googlebot). Step 2. SM checks status code is 200 (304 would mean there was no change). Step 3. SM sends page HTML, URL to DS, and gets 304 no change from the DS. Step 10. SM returns the unchanged html back to the search bot, or 304 status code

In step 4, the DS receives the html source of the page, and URL from SM. Step 6. DS parses html source to extract key SEO elements: title, meta description, robots, canonical, etc. The present invention will call these Page SEO State (PSS). Step 7. DS compares the extracted PSS with the stored PSS in the Correct SEO State Maps for the URL, and the hreflang tag(s) will be found to be correct. Step 8. DS notifies the real-time dashboard that a permanent fix was detected, and provides relevant details. Step 9. DS returns status code 304 no change to SM. Step 10. DS locks the Temporary Fixes Map, and removes the corresponding update record. Step 11. In this case, the URL received from the SM, and the correct hreflang tag(s) extracted from the stored PSS will be removed from the Temporary Fixes Map

If there is No Change (NC). Step 13. SM receives the html source of the page, from the webserver, for the URL previously found in the Temporary Fixes Map, when the visitor is a known search engine (like Googlebot). Step 14. SM checks status code is 304, which means there was no change. Step 15. SM looks up the URL in the Temporary Fixes Map, and doesn't find a match. Step 16. SM returns 304 status code with no content

The Alternate Tags Update Processes, Physical Alternate Tag Removed (PATR), Physical Alternate Changed (PATC) starts when in step 1, the SM receives, from the webserver, the html source of the page when the visitor is a known search engine (like Googlebot). Step 2. SM checks status code is 200 (304 would mean there was no change). Step 3. SM sends page HTML, URL to DS, and gets the fixed page HTML with the correct alternate tag(s). Step 10. SM returns the fixed html back to the search bot

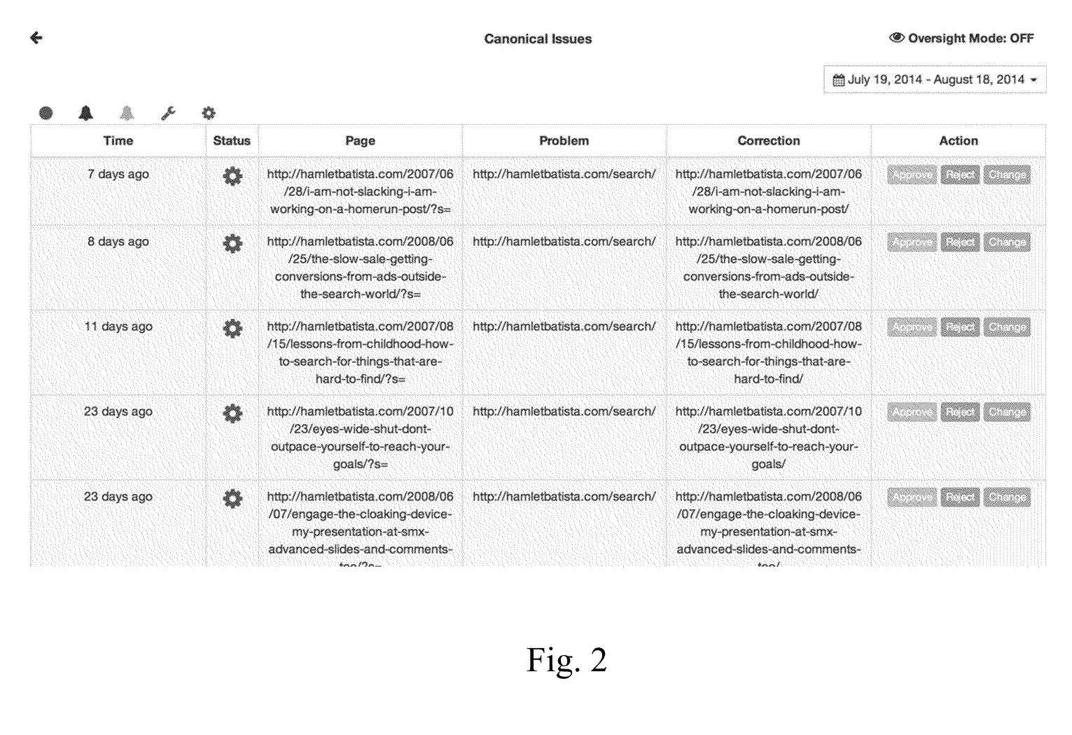

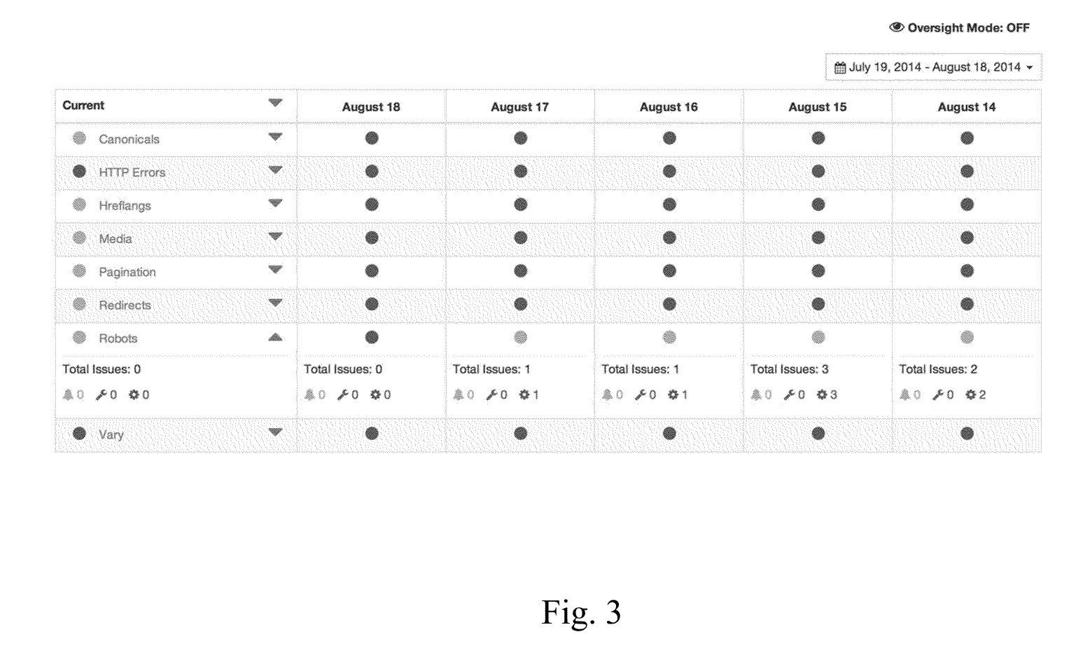

In step 4, the DS receives the html source of the page, and URL from SM. Step 5. DS parses html source to extract key SEO elements: title, meta description, robots, canonical, etc. The present invention will call these Page SEO State (PSS). Step 6. DS compares the extracted PSS with the stored PSS in the Correct SEO State Maps for the URL, and the alternate tag(s) will be found to be different. Step 7. DS notifies the real-time dashboard show in FIGS. 2-3 that a problem was detected, and provides relevant details. Step 8. DS updates the html received from SM, and inserts the correct alternate tag(s). Step 9. DS returns the fixed html back to the SM. Step 11. DS locks the Temporary Fixes Map, and adds a new update record. Step 12. In this case, the URL received from the SM, and the correct alternate tag(s) extracted from the stored PSS will be inserted in the Temporary Fixes Map. Step 13. DS notifies the real-time dashboard shown in FIGS. 2-3 that a temporary fix is in place

The Physical Hreflang Tag Added Back (PPTAB) starts when in step 1, the SM receives the html source of the page, from the webserver, when the visitor is a known search engine (like Googlebot). Step 2. SM checks status code is 200 (304 would mean there was no change). Step 3. SM sends page HTML, URL to DS, and gets 304 no change from the DS. Step 10. SM returns the unchanged html back to the search bot, or 304 status code

In step 4, the DS receives the html source of the page, and URL from SM step 6. DS parses html source to extract key SEO elements: title, meta description, robots, canonical, etc. The present invention will call these Page SEO State (PSS). Step 7. DS compares the extracted PSS with the stored PSS in the Correct SEO State Maps for the URL, and the alternate tag(s) will be found to be correct. Step 8. DS notifies the real-time dashboard that a permanent fix was detected, and provides relevant details. Step 9. DS returns status code 304 no change to SM. Step 10. DS locks the Temporary Fixes Map, and removes the corresponding update record. Step 11. In this case, the URL received from the SM, and the correct alternate tag(s) extracted from the stored PSS will be removed from the Temporary Fixes Map

If there is No Change (NC), Step 13. SM receives the html source of the page, from the webserver, for the URL previously found in the Temporary Fixes Map, when the visitor is a known search engine (like Googlebot). Step 14. SM checks status code is 304, which means there was no change. Step 15. SM looks up the URL in the Temporary Fixes Map, and doesn't find a match. Step 16. SM returns 304 status code with no content.

It is the same process as described for asynchronous mode because there is not extra work performed by DS. DS main responsibility is to report the Vary header issues and fixes to the real-time dashboard as shown in FIGS. 2-3.

The system is set to run on a computing device. A computing device on which the present invention can run would be comprised of a CPU, Hard Disk Drive, Keyboard, Monitor, CPU Main Memory and a portion of main memory where the system resides and executes. Any general-purpose computer with an appropriate amount of storage space is suitable for this purpose. Computer Devices like this are well known in the art and are not pertinent to the invention. The system can also be written in a number of different languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A system for search engine optimization executable and rendered on the display of a machine, the system comprising:
a web server storing and executing software;
the webserver communicating with a Server Module (SM) and a Daemon Service (DS);
the software directing the web server to execute the following steps:
the server module receives, from the webserver, the html source of the page when the visitor is a known search engine;
the SM checks the web server for a status code; and
the SM sends page HTML, URL to DS.

2. The system of claim 1, wherein
replacing or adding html elements when a 304 Not Modified on a file for which there is a temporary fix is detected;
removing the If-Modified-Since header from the incoming request;
storing the time in the request context maintained by the filter for the request lifetime;
returning a 200 OK with the html body;
returning the Last-Modified response header from any web server which supports If-Modified-Since and 304 Not Modified;
examining the Last-Modified response header;
if last-modified is <=the stored if-modified-since, this is equivalent to a 304 case—the web server would have returned a 304 if we had not removed the incoming If-Modified-Since header;
if there is no temporary fix,
replacing the 200 status code with a 304,
removing the body and any body related headers; or
if there is a temporary fix,
applying the fix.

3. The system of claim 1, wherein
the SM returns the untouched html; or
the SM returns status code step 503 (unavailable after) with a preconfigured expiration date/time; and
the search bot will not get the page this time, and will try again at a later time, as configured.

4. The system of claim 1, wherein
the DS receives the html source of the page, and URL from the SM.
the DS parses html source to extract key SEO elements: title, meta description, robots, and canonical;
the DS compares the extracted PSS with the stored PSS in the Correct SEO State Maps for the URL, and a known SEO tag will be found to be different;
the DS notifies the real-time dashboard that a problem was detected, and provides relevant details;
the DS locks the Temporary Fixes Map, and adds a new update record;
the URL received from the SM, and the correct SEO tag extracted from the stored PSS will be inserted in the Temporary Fixes Map;
the DS notifies the real-time dashboard that a temporary fix is in place;
the SM receives the html source of the page, from the webserver, for the URL found in the Temporary Fixes Map, when the visitor is a known search engine;
the SM checks status code and gets 304, which means there was no change;
the SM looks up the URL in the Temporary Fixes Map, and finds an update with the correct SEO tag; and
the SM parses HTML, and inserts SEO tag in the Virtual HTML Stream.

5. The system of claim 4, wherein
the SM receives the html source of the page, from the webserver, when the visitor is a known search engine;
the SM checks status code is 200;
the SM sends page HTML, URL and optionally checksum to DS;
the SM returns the untouched html, and
the SM returns status code step 503 with a preconfigured expiration date/time;
the DS receives the html source of the page, and URL from SM;
the DS parses html source to extract key SEO tags: title, meta description, robots, canonical, etc.;
the DS compares the extracted PSS with the stored PSS in the Correct SEO State Maps for the URL, and the SEO tag will be found to be correct;
the DS notifies the real-time dashboard that a permanent fix was detected, and provides relevant details;
the DS locks the Temporary Fixes Map, and removes the corresponding update record; and
the URL received from the SM, and the correct SEO tag extracted from the stored PSS will be removed from the Temporary Fixes Map.

6. The system of claim 5, wherein
the SM receives the html source of the page, from the webserver, for the URL previously found in the Temporary Fixes Map, when the visitor is a known search engine;
the SM checks status code is 304, which means there was no change;
the SM looks up the URL in the Temporary Fixes Map, and doesn't find a match; and
the SM returns 304 status code with no content.

7. The system of claim 5, wherein
the SM receives, from the webserver, the html source of the page when the visitor is a known search engine;
the SM checks status code is 200;
the SM sends page HTML, URL to DS;
the SM returns the untouched html, and
the SM returns status code 503 (unavailable after) with a preconfigured expiration date/time.

8. The system of claim 5, wherein
the DS receives the html source of the page, and URL from SM;
the DS reviews headers and parses html source to extract key SEO tags: title, meta description, robots, canonical, etc.;
the DS compares the extracted PSS with the stored PSS in the Correct SEO State Maps for the URL, and the page will be found to have the redirect SEO tag removed;
the DS notifies the real-time dashboard that a problem was detected, and provides relevant details;
the DS locks the Temporary Fixes Map, and adds a new update record;
the URL received from the SM, and the correct redirect extracted from the stored PSS will be inserted in the Temporary Fixes Map; and
the DS notifies the real-time dashboard that a temporary fix is in place.

9. The system of claim 5, wherein
the SM receives the html source of the page, from the webserver, for the URL found in the Temporary Fixes Map, when the visitor is a known search engine;
the SM checks status code and gets 304;
the SM looks up the URL in the Temporary Fixes Map, and finds an update indicating it needs to correctly redirect; and
the SM updates the Virtual HTTP Headers to add the correct redirect.

10. The system of claim 5, wherein
the SM receives the HTTP headers, and html source of the page, from the webserver, when the visitor is a known search engine;
the SM checks status code;
the SM looks up the URL in the Temporary Fixes Map, and finds a match;
the SM sends page URL to DS with no HTML body to indicate the redirect has been fixed;
the DS receives the http headers, and URL with no html source from SM;
the DS locks the Temporary Fixes Map, finds the URL and removes the corresponding update record;
the DS notifies the real-time dashboard that a permanent fix was detected, and provides relevant details.

11. The system of claim 1, wherein
the SM receives, from the webserver, the http headers, and html source of the page when the visitor is a known search engine;
the SM checks status code;
the SM looks up the URL in the Temporary Fixes Map, and finds no match;
the SM updates the Virtual HTTP Headers to add the correct redirect;
the SM sends page URL to DS with no HTML body to indicate the redirect problem the DS receives the http headers, no html source of the page, and URL from SM;
the DS locks the Temporary Fixes Map, doesn't find the URL and adds the corresponding update record;
the URL received from the SM, and the correct redirect from the stored PSS will be added to the Temporary Fixes Map;
the DS notifies the real-time dashboard that a permanent fix was detected, and provides relevant details
the SM receives the http headers, and html source of the page, from the webserver, for the URL found in the Temporary Fixes Map, when the visitor is a known search engine;
the SM checks status code is step;
the SM looks up the URL in the Temporary Fixes Map, and finds an update indicating it needs to correctly redirect;
the SM updates the Virtual HTTP Headers to add the correct redirect;
the SM receives the HTTP headers, and html source of the page, from the webserver, for the URL previously found in the Temporary Fixes Map, when the visitor is a known search engine;
the SM checks status code is 304 which means there was no change;
the SM looks up the URL in the Temporary Fixes Map, and doesn't find a match; and
the SM returns 304 status code with no content.

12. A method for search engine optimization executable and rendered on the display of a machine, the method comprising:
providing on and executing by a computer;
a Server Module (SM) and a Daemon Service (DS)
wherein the DS contains the SEO rules;
running a calibration step per website to establish the SEO rules
the SM caches the rules and there is no need to consult the DS for every user request;
fixes/transformation rules can be change at any point to override a system decision

13. The method of claim 12, wherein the operational mode is Async.

14. The method of claim 12, wherein the operational mode is Sync.

15. The method of claim 12, wherein the operational mode is Quicksync.

16. The method of claim 12, wherein the changes are transparent, and the fixes/transformation rules can be changed at any point to override a system decision

17. The method of claim 12, wherein the system runs the Server Module and Daemon Service in the same machine.

18. The method of claim 12, wherein the system runs the Server Module and Daemon Service in separate machines across the network.

19. The method of claim 12, further comprising static and dynamic SEO rules for most SEO elements.

20. The method of claim step 19, wherein dynamic rules use regular expressions and/or xpath expressions to generalize pages into groups where the same rule applies.

21. The method of claim 12, further comprising a dashboard presentation highlighting current and past SEO issues and fixes as green, yellow, and red states.
